(19) United States
(12) Patent Application Publication
(10) Pub. No.: US 2024/0236805 A9
(43) Pub. Date: Jul. 11, 2024

(54) TECHNIQUES FOR ENHANCING CONDITIONAL CHANGES OF A SERVING CELL

(71) Applicant: QUALCOMM Incorporated, San Diego, CA (US)

(72) Inventors: Jing LEI, San Diego, CA (US); Yongle WU, San Diego, CA (US); Jing JIANG, San Diego, CA (US)

(21) Appl. No.: 18/482,660

(22) Filed: Oct. 6, 2023

Related U.S. Application Data
(60) Provisional application No. 63/380,211, filed on Oct. 19, 2022.

(51) Int. Cl. H04W 36/36; H04W 36/00

(52) U.S. Cl. CPC H04W 36/362; H04W 36/0058

(57) ABSTRACT

Methods, systems, and devices for wireless communication are described. A user equipment (UE) may transmit a message indicating UE assistance information (UAI). In some examples, the UE may transmit a request for network assistance information (NAI) for candidate cells. The UE may receive a control message indicating the NAI and a set of candidate cells for a conditional serving cell change. The UE may perform the conditional serving cell change based on the NAI for one or more candidate cells. In some examples, the UE may select a target cell from the set of candidate cells, and the UE may receive a control message indicating one or more coverage enhancement schemes supported by the target cell. The UE may perform a random access procedure based on the one or more coverage enhancement schemes supported by the target cell.

### CROSS REFERENCE

The present Application for Patent claims the benefit of U.S. Provisional Patent Application No. 63/380,211 by LEI et al., entitled “TECHNIQUES FOR ENHANCING CONDITIONAL CHANGES OF A SERVING CELL,” filed Oct. 19, 2022, assigned to the assignee hereof, and expressly incorporated by reference herein.

### FIELD OF TECHNOLOGY

The following relates to wireless communications, including techniques for enhancing conditional changes of a serving cell.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some wireless communications systems, a UE may be configured to perform cell change procedures, such as handover procedures. For example, a UE may perform a handover procedure from a source cell to a target cell if the signal quality between the UE and the source cell drops (e.g., due to UE mobility).

### SUMMARY

The described techniques relate to improved methods, systems, devices, and apparatuses that support techniques for enhancing conditional changes of a serving cell. For example, the described techniques provide for a user equipment (UE) to transmit, to a network entity, a message indicating UE assistance information (UAI). In some examples, the UE may transmit (e.g., in the UAI) a request for network assistance information (NAI) from the network entity. In response to the request, the network entity may transmit a control message that indicates the NAI, which may include NAI for one or more candidate cells from a set of candidate cells for a conditional change of a serving cell of the UE. The UE may perform the conditional cell change based on the NAI and on one or more conditions being satisfied for the conditional change. The UE may select a target cell from the set of candidate cells and the UE may receive, from a network entity associated with the target cell, a control message indicating one or more coverage enhancements (e.g., coverage enhancement schemes) supported by the target cell. The UE may perform a random access procedure based on the one or more coverage enhancement schemes supported by the target cell.

An apparatus for wireless communication at a UE is described. The apparatus may include a processor, memory coupled with the processor, and instructions stored in the memory. The instructions may be executable by the processor to cause the apparatus to transmit, to a network entity associated with a serving cell, a message indicating UAI for a conditional change of the serving cell, a request for NAI for the conditional change of the serving cell, or both, receive, from the network entity, a control message that indicates a set of candidate cells for the conditional change of the serving cell, and perform the conditional change of the serving cell to a target cell of the set of candidate cells based on the NAI and on one or more conditions being satisfied for the conditional change of the serving cell.

A method for wireless communication at a UE is described. The method may include transmitting, to a network entity associated with a serving cell, a message indicating UAI for a conditional change of the serving cell, a request for NAI for the conditional change of the serving cell, or both, receiving, from the network entity, a control message that indicates a set of candidate cells for the conditional change of the serving cell, and performing the conditional change of the serving cell to a target cell of the set of candidate cells based on the NAI and on one or more conditions being satisfied for the conditional change of the serving cell.

Another apparatus for wireless communication at a UE is described. The apparatus may include means for transmitting, to a network entity associated with a serving cell, a message indicating UAI for a conditional change of the serving cell, a request for NAI for the conditional change of the serving cell, or both, means for receiving, from the network entity, a control message that indicates a set of candidate cells for the conditional change of the serving cell, and means for performing the conditional change of the serving cell to a target cell of the set of candidate cells based on the NAI and on one or more conditions being satisfied for the conditional change of the serving cell.

A non-transitory computer-readable medium storing code for wireless communication at a UE is described. The code may include instructions executable by a processor to transmit, to a network entity associated with a serving cell, a message indicating UAI for a conditional change of the serving cell, a request for NAI for the conditional change of the serving cell, or both, receive, from the network entity, a control message that indicates a set of candidate cells for the conditional change of the serving cell, and perform the conditional change of the serving cell to a target cell of the set of candidate cells based on the NAI and on one or more conditions being satisfied for the conditional change of the serving cell.

In some examples of the method, apparatuses, and non-transitory computer-readable medium described herein, the UAI indicates one or more coverage enhancement schemes supported by the UE and the control message includes the NAI in response to the UAI and the request, the NAI being associated with at least one candidate cell of the set of candidate cells that support at least one of the one or more coverage enhancement schemes supported by the UE for downlink transmissions or uplink transmissions.

In some examples of the method, apparatuses, and non-transitory computer-readable medium described herein, the NAI includes a loading status of one or more candidate cells of the set of candidate cells, a random access type associated with the one or more candidate cells, an indication of whether the one or more candidate cells support dynamic waveform switching, an indication of whether the one or more candidate cells support one or more coverage enhancement schemes, an indication of an energy saving status associated with each network entity providing the one or more candidate cells, an indication of whether the one or more candidate cells support data forwarding, or any combination thereof.

In some examples of the method, apparatuses, and non-transitory computer-readable medium described herein, the NAI includes an indication of a time-dependency associated with the set of candidate cells, a location-dependency associated with the set of candidate cells, or both, and the method, apparatuses, and non-transitory computer-readable medium may include further operations, features, means, or instructions for evaluating the one or more conditions for the conditional change of the serving cell based on the time-dependency, the location-dependency, or both, where the evaluating may be performed at respective times, at respective locations of the UE, or both and modifying the set of candidate cells for evaluation in response to the one or more conditions failing to be satisfied for the conditional change of the serving cell based on the evaluating, where the modified set of candidate cells includes one or more candidate cells activated for evaluation, one or more candidate cells removed from evaluation, or both.

In some examples of the method, apparatuses, and non-transitory computer-readable medium described herein, the UAI further indicates the request for the NAI and the method, apparatuses, and non-transitory computer-readable medium may include further operations, features, means, or instructions for receiving, from the network entity or a candidate cell of the set of candidate cells, one or more messages indicating the NAI in response to the request, the NAI being associated with at least one candidate cell of the set of candidate cells, where performing the conditional change of the serving cell may be based on receiving the NAI.

Some examples of the method, apparatuses, and non-transitory computer-readable medium described herein may further include operations, features, means, or instructions for determining an offset value, or a hysteresis value, or both, for each candidate cell of the set of candidate cells, where each offset value, or each hysteresis value, or both, may be mapped to a system loading status of a candidate cell, a network energy saving status of the candidate cell, one or more coverage enhancement schemes supported by the candidate cell, or any combination thereof, performing measurements of signals associated with respective candidate cells of the set of candidate cells and signals associated with the serving cell, and evaluating each candidate cell of the set of candidate cells for the conditional change of the serving cell based on the measurements, the offset value, or the hysteresis value, or any combination thereof.

Some examples of the method, apparatuses, and non-transitory computer-readable medium described herein may further include operations, features, means, or instructions for selecting the target cell from the set of candidate cells based on a sum of a measurement value for the target cell, an offset value for the target cell, and a hysteresis value for the target cell being greater than a measurement value for the serving cell.

Some examples of the method, apparatuses, and non-transitory computer-readable medium described herein may further include operations, features, means, or instructions for refraining from selecting a first candidate cell from the set of candidate cells based on a sum of a measurement value for the first candidate cell, an offset value for the first candidate cell, and a hysteresis value for the first candidate cell being less than a measurement value for the serving cell.

Some examples of the method, apparatuses, and non-transitory computer-readable medium described herein may further include operations, features, means, or instructions for determining a set of thresholds for the conditional change of the serving cell, each threshold of the set of thresholds corresponding to the system loading status of a candidate cell, the network energy saving status of the candidate cell, one or more coverage enhancement schemes supported by the candidate cell, or any combination thereof, where each candidate the set of candidate cells may be evaluated based on the set of thresholds, the offset value, and the hysteresis value.

Some examples of the method, apparatuses, and non-transitory computer-readable medium described herein may further include operations, features, means, or instructions for selecting the target cell from the set of candidate cells based on a minimum of an offset value for the target cell and a hysteresis value for the target cell being less than a threshold value from the set of thresholds.

Some examples of the method, apparatuses, and non-transitory computer-readable medium described herein may further include operations, features, means, or instructions for refraining from selecting a first candidate cell from the set of candidate cells based on a minimum of an offset value for the first candidate cell and a hysteresis value for the first candidate cell being greater than a threshold value from the set of thresholds.

In some examples of the method, apparatuses, and non-transitory computer-readable medium described herein, the control message further indicates the set of candidate cells and a first configuration of the one or more conditions for performing the conditional change of the serving cell and the method, apparatuses, and non-transitory computer-readable medium may include further operations, features, means, or instructions for receiving a second control message indicating a second configuration of the one or more conditions, where performing the conditional change of the serving cell to the target cell may be based on the second configuration of the one or more conditions.

In some examples of the method, apparatuses, and non-transitory computer-readable medium described herein, the UAI includes an indication of a preferred waveform, one or more coverage enhancement schemes supported by the UE, a buffer status report, a power headroom report, a preferred power budget for power aggregation at the UE, an estimate of a location of the UE, an estimate of a velocity of the UE, a report for a buffer status or a power headroom of the UE, an indication of one or more power saving configurations, a report of a capability of the UE associated with single-connectivity or multi-connectivity, or any combination thereof.

An apparatus for wireless communication at a UE is described. The apparatus may include a processor, memory coupled with the processor, and instructions stored in the memory. The instructions may be executable by the processor to cause the apparatus to select a target cell from a set of one or more candidate cells for a conditional change of a serving cell, receive, from a network entity associated with the target cell, a control message indicating one or more coverage enhancement schemes supported by the target cell, and perform a random access procedure with the network entity based on the conditional change of the serving cell, where signaling that is part of the random access procedure is based on the one or more coverage enhancement schemes supported by the target cell.

A method for wireless communication at a UE is described. The method may include selecting a target cell from a set of one or more candidate cells for a conditional change of a serving cell, receiving, from a network entity associated with the target cell, a control message indicating one or more coverage enhancement schemes supported by the target cell, and performing a random access procedure with the network entity based on the conditional change of the serving cell, where signaling that is part of the random access procedure is based on the one or more coverage enhancement schemes supported by the target cell.

Another apparatus for wireless communication at a UE is described. The apparatus may include means for selecting a target cell from a set of one or more candidate cells for a conditional change of a serving cell, means for receiving, from a network entity associated with the target cell, a control message indicating one or more coverage enhancement schemes supported by the target cell, and means for performing a random access procedure with the network entity based on the conditional change of the serving cell, where signaling that is part of the random access procedure is based on the one or more coverage enhancement schemes supported by the target cell.

A non-transitory computer-readable medium storing code for wireless communication at a UE is described. The code may include instructions executable by a processor to select a target cell from a set of one or more candidate cells for a conditional change of a serving cell, receive, from a network entity associated with the target cell, a control message indicating one or more coverage enhancement schemes supported by the target cell, and perform a random access procedure with the network entity based on the conditional change of the serving cell, where signaling that is part of the random access procedure is based on the one or more coverage enhancement schemes supported by the target cell.

In some examples of the method, apparatuses, and non-transitory computer-readable medium described herein, receiving the control message indicating the one or more coverage enhancement schemes supported by the target cell may include operations, features, means, or instructions for receiving the control message indicating that the target cell supports dynamic switching of an uplink waveform for the signaling that may be part of the random access procedure. Some examples of the method, apparatuses, and non-transitory computer-readable medium described herein may further include operations, features, means, or instructions for receiving a message indicating an uplink waveform supported by the target cell, the message including a downlink control information message, a medium access control-control element message, or a radio resource control message, and modifying a waveform of one or more uplink messages to the network entity for the random access procedure based on the target cell supporting the dynamic switching of the uplink waveform and receiving the message indicating the uplink waveform.

In some examples of the method, apparatuses, and non-transitory computer-readable medium described herein, receiving the control message indicating the one or more coverage enhancement schemes supported by the target cell may include operations, features, means, or instructions for receiving the control message indicating that the target cell supports repetitions, frequency hopping, demodulation reference signal bundling, scaling of a transport block size, lowering of a modulation order, lowering of a coding rate, slot or sub-slot aggregation, or any combination thereof, for the signaling that may be part of the random access procedure. Some examples of the method, apparatuses, and non-transitory computer-readable medium described herein may further include operations, features, means, or instructions for transmitting or receiving, for the random access procedure, one or more messages to the network entity or from the network entity based on receiving the control message and according to the repetitions, the frequency hopping, the demodulation reference signal bundling, the scaling of the transport block size, the lowering of the modulation order, the lowering of the coding rate, the slot or sub-slot aggregation, or any combination thereof.

In some examples of the method, apparatuses, and non-transitory computer-readable medium described herein, receiving the control message indicating the one or more coverage enhancement schemes supported by the target cell may include operations, features, means, or instructions for receiving the control message indicating that the target cell supports maximum power reduction, or peak-to-average power ratio reduction, or both. Some examples of the method, apparatuses, and non-transitory computer-readable medium described herein may further include operations, features, means, or instructions for transmitting one or more messages to the network entity using the maximum power reduction, or peak-to-average power ratio reduction, or both.

In some examples of the method, apparatuses, and non-transitory computer-readable medium described herein, receiving the control message indicating the one or more coverage enhancement schemes supported by the target cell may include operations, features, means, or instructions for receiving the control message indicating that the target cell supports modification of one or more power control parameters for uplink messages to the network entity. Some examples of the method, apparatuses, and non-transitory computer-readable medium described herein may further include operations, features, means, or instructions for transmitting one or more messages to the network entity based on modifying the one or more power control parameters, where the one or more power control parameters may be modified based on uplink power aggregation and a specific absorption rate at the UE.

In some examples of the method, apparatuses, and non-transitory computer-readable medium described herein, receiving the control message indicating the one or more coverage enhancement schemes supported by the target cell may include operations, features, means, or instructions for receiving the control message indicating that the target cell supports scheduling of one or more reference signals that may be associated with distance-based cell selection procedures. Some examples of the method, apparatuses, and non-transitory computer-readable medium described herein may further include operations, features, means, or instructions for measuring the one or more reference signals from the target cell for one or more distance-based cell selection procedures.

Some examples of the method, apparatuses, and non-transitory computer-readable medium described herein may further include operations, features, means, or instructions for transmitting a capability message indicating a capability of the UE to support the one or more coverage enhancement schemes, where receiving the control message indicating the one or more coverage enhancement schemes supported by the target cell may be based on the capability of the UE to support the one or more coverage enhancement schemes.

An apparatus for wireless communication at a network entity is described. The apparatus may include a processor, memory coupled with the processor, and instructions stored in the memory. The instructions may be executable by the processor to cause the apparatus to receive, from a UE, a message indicating UAI for a conditional change of a serving cell, a request for NAI for the conditional change of the serving cell, or both and transmit, to the UE, a control message that indicates a set of candidate cells for the conditional change of the serving cell.

A method for wireless communication at a network entity is described. The method may include receiving, from a UE, a message indicating UAI for a conditional change of a serving cell, a request for NAI for the conditional change of the serving cell, or both and transmitting, to the UE, a control message that indicates a set of candidate cells for the conditional change of the serving cell.

Another apparatus for wireless communication at a network entity is described. The apparatus may include means for receiving, from a UE, a message indicating UAI for a conditional change of a serving cell, a request for NAI for the conditional change of the serving cell, or both and means for transmitting, to the UE, a control message that indicates a set of candidate cells for the conditional change of the serving cell.

A non-transitory computer-readable medium storing code for wireless communication at a network entity is described. The code may include instructions executable by a processor to receive, from a UE, a message indicating UAI for a conditional change of a serving cell, a request for NAI for the conditional change of the serving cell, or both and transmit, to the UE, a control message that indicates a set of candidate cells for the conditional change of the serving cell.

In some examples of the method, apparatuses, and non-transitory computer-readable medium described herein, the UAI indicates one or more coverage enhancement schemes supported by the UE and the control message includes the NAI in response to the UAI and the request, the NAI being associated with at least one candidate cell of the set of candidate cells that support at least one of the one or more coverage enhancement schemes supported by the UE for downlink transmissions or uplink transmissions.

Some examples of the method, apparatuses, and non-transitory computer-readable medium described herein may further include operations, features, means, or instructions for transmitting the request for the NAI to each network entity associated with respective candidate cells of the set of candidate cells and receiving the NAI for the respective candidate cells in response to the request for the NAI, where the one or more messages indicating the NAI includes the NAI for the respective candidate cells.

In some examples of the method, apparatuses, and non-transitory computer-readable medium described herein, the NAI includes a loading status of one or more candidate cells of the set of candidate cells, a random access type associated with the one or more candidate cells, an indication of whether the one or more candidate cells support dynamic waveform switching, an indication of whether the one or more candidate cells support one or more coverage enhancement schemes, an indication of an energy saving status associated with each network entity providing the one or more candidate cells, an indication of whether the one or more candidate cells support data forwarding, or any combination thereof.

In some examples of the method, apparatuses, and non-transitory computer-readable medium described herein, the NAI includes an indication of a time-dependency associated with the set of candidate cells, a location-dependency associated with the set of candidate cells, or both.

In some examples of the method, apparatuses, and non-transitory computer-readable medium described herein, the UAI indicates the request for the NAI and the method, apparatuses, and non-transitory computer-readable medium may include further operations, features, means, or instructions for transmitting, to the UE, one or more messages indicating the NAI in response to the request, the NAI being associated with at least one candidate cell of the set of candidate cells.

In some examples of the method, apparatuses, and non-transitory computer-readable medium described herein, the UAI includes an indication of a preferred waveform, one or more coverage enhancement schemes supported by the UE, a buffer status report, a power headroom report, a preferred power budget for power aggregation at the UE, an estimate of a location of the UE, an estimate of a velocity of the UE, a report for a buffer status or a power headroom of the UE, an indication of one or more power saving configurations, a report of a capability of the UE associated with single-connectivity or multi-connectivity, or any combination thereof.

An apparatus for wireless communication at a network entity is described. The apparatus may include a processor, memory coupled with the processor, and instructions stored in the memory. The instructions may be executable by the processor to cause the apparatus to receive a message indicating that a UE has selected a target cell associated with the network entity for a conditional change of a serving cell, transmit, to the UE and based on receiving the message, a control message indicating one or more coverage enhancement schemes supported by the target cell, and perform a random access procedure with the UE based on the conditional change of the serving cell, where signaling that is part of the random access procedure is based on the one or more coverage enhancement schemes supported by the target cell.

A method for wireless communication at a network entity is described. The method may include receiving a message indicating that a UE has selected a target cell associated with the network entity for a conditional change of a serving cell, transmitting, to the UE and based on receiving the message, a control message indicating one or more coverage enhancement schemes supported by the target cell, and performing a random access procedure with the UE based on the conditional change of the serving cell, where signaling that is part of the random access procedure is based on the one or more coverage enhancement schemes supported by the target cell.

Another apparatus for wireless communication at a network entity is described. The apparatus may include means for receiving a message indicating that a UE has selected a target cell associated with the network entity for a conditional change of a serving cell, means for transmitting, to the UE and based on receiving the message, a control message indicating one or more coverage enhancement schemes supported by the target cell, and means for performing a random access procedure with the UE based on the conditional change of the serving cell, where signaling that is part of the random access procedure is based on the one or more coverage enhancement schemes supported by the target cell.

A non-transitory computer-readable medium storing code for wireless communication at a network entity is described. The code may include instructions executable by a processor to receive a message indicating that a UE has selected a target cell associated with the network entity for a conditional change of a serving cell, transmit, to the UE and based on receiving the message, a control message indicating one or more coverage enhancement schemes supported by the target cell, and perform a random access procedure with the UE based on the conditional change of the serving cell, where signaling that is part of the random access procedure is based on the one or more coverage enhancement schemes supported by the target cell.

In some examples of the method, apparatuses, and non-transitory computer-readable medium described herein, transmitting the control message indicating the one or more coverage enhancement schemes supported by the target cell may include operations, features, means, or instructions for transmitting the control message indicating that the target cell supports dynamic switching of an uplink waveform for the signaling that may be part of the random access procedure, where one or more uplink messages from the UE for the random access procedure may have a modified waveform based on the target cell supporting the dynamic switching of the uplink waveform.

In some examples of the method, apparatuses, and non-transitory computer-readable medium described herein, transmitting the control message indicating the one or more coverage enhancement schemes supported by the target cell may include operations, features, means, or instructions for transmitting the control message indicating that the target cell supports repetitions, frequency hopping, demodulation reference signal bundling, scaling of a transport block size, lowering of a modulation order, lowering of a coding rate, slot or sub-slot aggregation, or any combination thereof, for the signaling that may be part of the random access procedure. Some examples of the method, apparatuses, and non-transitory computer-readable medium described herein may further include operations, features, means, or instructions for receiving or transmitting, for the random access procedure, one or more messages from the UE or to the UE based on transmitting the control message and in accordance with the repetitions, frequency hopping, demodulation reference signal bundling, scaling of a transport block size, lowering of a modulation order, lowering of a coding rate, slot or sub-slot aggregation, or any combination thereof.

In some examples of the method, apparatuses, and non-transitory computer-readable medium described herein, transmitting the control message indicating the one or more coverage enhancement schemes supported by the target cell may include operations, features, means, or instructions for transmitting the control message indicating that the target cell supports maximum power reduction, or peak-to-average power ratio reduction, or both. Some examples of the method, apparatuses, and non-transitory computer-readable medium described herein may further include operations, features, means, or instructions for receiving one or more messages from the UE in accordance with the maximum power reduction, or the peak-to-average power ratio reduction, or both.

In some examples of the method, apparatuses, and non-transitory computer-readable medium described herein, transmitting the control message indicating the one or more coverage enhancement schemes supported by the target cell may include operations, features, means, or instructions for transmitting the control message indicating that the target cell supports modification of one or more power control parameters for uplink messages to the network entity. Some examples of the method, apparatuses, and non-transitory computer-readable medium described herein may further include operations, features, means, or instructions for receiving, from the UE, one or more messages having one or more modified power control parameters based on the target cell supporting the modification of the one or more power control parameters.

In some examples of the method, apparatuses, and non-transitory computer-readable medium described herein, transmitting the control message indicating the one or more coverage enhancement schemes supported by the target cell may include operations, features, means, or instructions for transmitting the control message indicating that the target cell supports scheduling of one or more reference signals that may be associated with distance-based cell selection. Some examples of the method, apparatuses, and non-transitory computer-readable medium described herein may further include operations, features, means, or instructions for transmitting the one or more reference signals to the UE based on the target cell supporting the scheduling of the one or more reference signals.

Some examples of the method, apparatuses, and non-transitory computer-readable medium described herein may further include operations, features, means, or instructions for receiving a capability message indicating a capability of the UE to support the one or more coverage enhancement schemes, where transmitting the control message indicating the one or more coverage enhancement schemes supported by the target cell may be based on the capability of the UE to support the one or more coverage enhancement schemes.

### BRIEF DESCRIPTION OF THE DRAWINGS

FIG. 1 illustrates an example of a wireless communications system that supports techniques for enhancing conditional changes of a serving cell in accordance with one or more aspects of the present disclosure.

FIG. 2 illustrates an example of a wireless communications system that supports techniques for enhancing conditional changes of a serving cell in accordance with one or more aspects of the present disclosure.

FIG. 3 illustrates an example of a cell evaluation process that supports techniques for enhancing conditional changes of a serving cell in accordance with one or more aspects of the present disclosure.

FIG. 4 illustrates an example of a process flow that supports techniques for enhancing conditional changes of a serving cell in accordance with one or more aspects of the present disclosure.

FIG. 5 illustrates an example of a process flow that supports techniques for enhancing conditional changes of a serving cell in accordance with one or more aspects of the present disclosure.

FIGS. 6 and 7 illustrate block diagrams of devices that support techniques for enhancing conditional changes of a serving cell in accordance with one or more aspects of the present disclosure.

FIG. 8 illustrates a block diagram of a communications manager that supports techniques for enhancing conditional changes of a serving cell in accordance with one or more aspects of the present disclosure.

FIG. 9 illustrates a diagram of a system including a device that supports techniques for enhancing conditional changes of a serving cell in accordance with one or more aspects of the present disclosure.

FIGS. 10 and 11 illustrate block diagrams of devices that support techniques for enhancing conditional changes of a serving cell in accordance with one or more aspects of the present disclosure.

FIG. 12 illustrates a block diagram of a communications manager that supports techniques for enhancing conditional changes of a serving cell in accordance with one or more aspects of the present disclosure.

FIG. 13 illustrates a diagram of a system including a device that supports techniques for enhancing conditional changes of a serving cell in accordance with one or more aspects of the present disclosure.

FIGS. 14 through 20 illustrate flowcharts showing methods that support techniques for enhancing conditional changes of a serving cell in accordance with one or more aspects of the present disclosure.

### DETAILED DESCRIPTION

Some wireless communications systems may support conditional handover procedures or a conditional change of a primary cell of a secondary cell group (e.g., conditional primary secondary cell (PSCell) change procedures), or both. For example, a user equipment (UE) may be in communication with a source network entity (e.g., a network entity associated with a serving cell), and based on one or more measurements from the UE, the source network entity may transmit a control message to the UE including a list of candidate cells for a conditional cell change. The UE may store the list and perform measurements associated with one or more of the candidate cells in the list. Over time, the UE may evaluate conditions (e.g., signal quality) for the conditional cell change, and if some conditions are met, the UE may be triggered to perform the cell change to one of the candidate cells in the list.

In some implementations, data corresponding to a UE may be forwarded from a source cell to candidate cells before the UE executes a conditional cell change. As the UE may select a single candidate cell as a target cell for the conditional cell change, however, the early data forwarding may result in increased overhead and wasted transmission resources by forwarding the UE data to the candidate cells that were not selected. In some cases, the target cell may serve a relatively large quantity of other UEs and may have limited resources available for the UE, and if the UE selects the target cell based on signal quality alone, the UE may experience significant latency (e.g., due to the limited resources) when trying to perform a random access procedure with the candidate cell. Further, there may be different capabilities of UEs and different SSB types available in some wireless communications systems, which may increase the complexity of measurements for a conditional cell change. For example, a source cell may configure a UE to perform a quality measurement for a target cell based on a non-cell-defining SSB (NCD-SSB), but a random access procedure for the target cell may be based on a cell-defining SSB (CD-SSB). This may result in the UE predicting a relatively high signal quality based on the quality measurement, but the random access procedure may be associated with a lower signal quality than the quality measurement would otherwise predict. Thus, conditional handover and conditional PSCell change procedures may face various challenges, particularly in view of new and emerging technologies and techniques.

Various aspects relate generally to a source cell transmitting control messaging to a UE to indicate various coverage enhancements for a conditional cell change (e.g., conditional handover procedure or a conditional PSCell change procedure). For example, the UE may be configured with dynamic switching of uplink waveforms towards a target cell, dynamic indication of repetitions or frequency hopping towards the target cell, dynamic indication of a maximum power reduction or a peak-to-average ratio reduction, dynamic switching of power control parameters for random access or uplink channels based on a dynamic power aggregation on uplink and a specific absorption rate (SAR) compliance report of the UE, or dynamic scheduling of an additional reference signal for measurements, or any combination thereof.

Additionally, or alternatively, the UE may transmit UAI and a request for NAI to a network entity. In some examples, the UAI, the NAI request, or both may be transmitted to a serving network entity via one or more messages (e.g., via a radio resource control (RRC) message, via a medium access control-control element (MAC-CE), uplink control information (UCI), a random access message, or the like), or the UAI, the NAI request, or both may be multiplexed with other information, such as measurements, buffer status reporting, power headroom reporting, or other reporting, for example, via an uplink channel (e.g., via a physical uplink shared channel (PUSCH)). The network entity may transmit NAI in response to the request, which may include a list of candidate cells as well as additional information that may be used by the UE to make a target cell decision for the conditional cell change. In some examples, the NAI may include system loading status of one or more candidate cells, an energy saving status of the one or more candidate cells, an indication of coverage enhancement schemes supported by the one or more candidate cells, or any combination thereof. In some aspects, the NAI may include a time- or location-dependent list of candidate cells that may be mapped to different locations or areas associated with a trajectory of UE's movement. In some examples, the NAI may indicate different types of random access procedures that supported by respective candidate cells, an indication of whether support for early data forwarding by the target cells, or both, among other examples.

Particular aspects of the subject matter described in this disclosure can be implemented to realize one or more of the following potential advantages. The procedures described herein for conditional changing of a serving cell may lead to reduced processing in a UE, a network entity or both. Further, the conditional changing may lead to increased communication efficiency and robustness, which may improve user experience via longer battery life and improved reliability.

Aspects of the disclosure are initially described in the context of wireless communications systems. Aspects of the disclosure are also described in the context of processes and process flows. Aspects of the disclosure are further illustrated by and described with reference to apparatus diagrams, system diagrams, and flowcharts that relate to techniques for enhancing conditional changes of a serving cell.

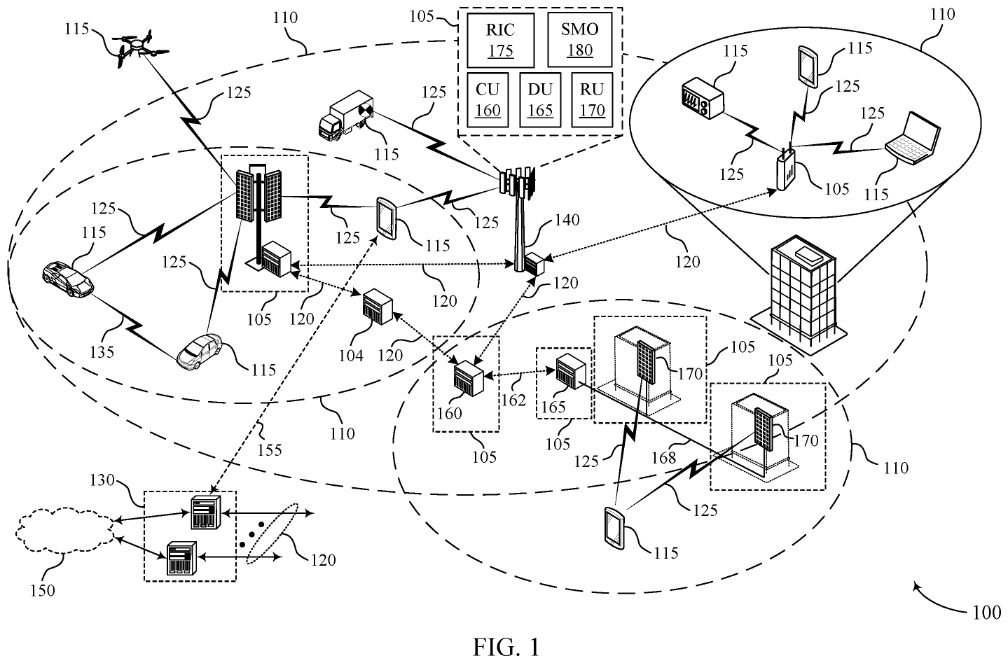

FIG. 1 illustrates an example of a wireless communications system 100 that supports techniques for enhancing conditional changes of a serving cell in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160.

Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for enhancing conditional changes of a serving cell as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNB s or gNBs, small cell eNB s or gNB s, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (0f) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, a UE 115 may be transferred from a serving cell associated with or provided by a network entity (known as the source network entity 105) to another network entity 105 (known as the target network entity 105). For example, the UE 115 may be moving into the coverage area of the target network entity 105, or the target network entity 105 may be capable of providing relatively better service for the UE 115 or may relive the source network entity 105 of excess load. The transition may be referred to as a “handover.” Prior to a handover, the source network entity 105 may configure the UE 115 with procedures for measuring the signal quality of one or more neighboring network entities 105 (which may be referred to as candidate network entities providing one or more candidate cells). The UE 115 may then respond with a measurement report. The source network entity 105 may use the measurement report to make a handover decision, and the decision may be based on some radio resource management (RRM) factors, such as network load and interference mitigation, among other examples. When the handover decision is made, the source network entity 105 may send a handover request message to the target network entity 105, which may include context information to prepare the target network entity 105 to serve the UE 115. The target network entity 105 may make an admission control decision, for example, to ensure that the quality of service (QoS) standards of the UE 115 may be met. The target network entity 105 may then configure resources for the incoming UE 115 and send a handover request acknowledge message to the source network entity 105, which may include RRC information to be passed on to the UE 115. The source network entity 105 may then direct the UE 115 to perform the handover and pass a status transfer message to the target network entity 105 with packet data convergence protocol (PDCP) bearer status information. The UE 115 may attach to the target network entity via a RACH procedure.

To perform the RACH procedure, a UE 115 may transmit a RACH preamble to a network entity 105. For example, for contention-based random access procedures, the RACH preamble may be randomly selected from a set of 64 predetermined sequences. This may enable the network entity 105 to distinguish between multiple UEs 115 trying to access the system simultaneously. The network entity 105 may respond with a random access response that provides an uplink resource grant, a timing advance, and a temporary C-RNTI. The UE 115 may then transmit an RRC connection request along with a TMSI (if the UE 115 has previously been connected to the same wireless network) or a random identifier. The RRC connection request may also indicate the reason the UE 115 is connecting to the network (e.g., emergency, signaling, data exchange, etc.). The network entity 105 may respond to the connection request with a contention resolution message addressed to the UE 115, which may provide a new C-RNTI. If the UE 115 receives a contention resolution message with the correct identification, the UE 115 may proceed with RRC setup. If the UE 115 does not receive a contention resolution message (e.g., if there is a conflict with another UE 115), the UE 115 may repeat the RACH process by transmitting a new RACH preamble. In other examples, such as contention-free random access procedures, a UE 115 may receive a message (e.g., RRC or DCI) from a network entity assigning a RACH preamble to the UE 115. As such, the UE 115 may transmit a random access request message based on the assigned RACH preamble, and the UE 115 may receive a random access response from the network entity 105. In some cases, a RACH procedure may include a four-step RACH procedure or a two-step RACH procedure.

The wireless communications system 100 may accordingly support cell change procedures (e.g., handover), where the cell change procedures may include a UE 115 performing one or more measurements (e.g., of one or more reference signals) associated with one or more candidate network entities 105 (e.g., associated with a candidate cell). The UE 115 may transmit control messages indicating measurement reports to a source network entity 105, and the source network entity 105 may initiate the cell change procedures based on the measurement reports. For example, the source network entity 105 may determine that a signal quality associated with signals between the source network entity 105 and the UE 115 is relatively low (e.g., below a threshold value), and the source network entity 105 may transmit a control message (e.g., a handover command) to the UE 115 to indicate the UE 115 to initiate a cell change.

In some cases, however, the cell change procedure (e.g., handover) may not succeed. For example, one or more measurement reports transmitted by the UE 115 may not reach the source network entity 105. Additionally, or alternatively, the control message transmitted by the source network entity 105 indicating the UE 115 to initiate cell change procedures may not reach the UE 115, which may be due to, for example, poor signal quality for transmissions between the UE 115 and the source network entity 105. Accordingly, the UE 115 may not be able to switch to a new cell (e.g., serving or source cell), despite the signal quality associated with the current source cell being relatively poor. For example, if the UE 115 is experiencing high mobility, the UE 115 may move out of range of the source cell.

In some examples, the wireless communications system 100 may support conditional cell change procedures (e.g., conditional handover, conditional PSCell change). For example, the source network entity 105 may transmit a control message (e.g., an RRCReconfiguration message) to the UE 115 that may include a list of candidate cells for a conditional cell change. The UE 115 may store the list and perform measurements associated with one or more of the candidate cells in the list. The UE 115 may evaluate conditions (e.g., signal quality) for the conditional cell change, and if some conditions are met, the UE 115 may be triggered to perform the cell change to one of the candidate cells in the list. Accordingly, the UE 115 may avoid issues possible with non-conditional cell change procedures, such as the source network entity 105 not receiving measurement reports from the UE 115.

Conditional cell change procedures may face various challenges, however, particularly in view of new and emerging technologies. For example, a source network entity 105 may perform early data forwarding to one or more candidate network entities 105 (e.g., network entities 105 associated with a candidate cell). For example, the source network entity 105 may forward data associated with the UE 115 to one or more candidate network entities 105 prior to the UE 115 selecting a candidate cell as a target cell to switch to. In some cases, however, a candidate network entity 105 may not support early data forwarding of data associated with the UE 115. The UE 115 may select this candidate network entity 105, for example, if the UE 115 determines that the candidate network entity 105 has a highest signal quality values (e.g., reference signal received power (RSRP) values, reference signal received quality (RSRQ) values) relative to the other candidate network entities 105 in the list. Thus, the early data forwarding may result in increased overhead and wasted transmission resources as the selected candidate network entity 105 may not support early data forwarding and the source network entity 105 may forward the UE data to candidate network entities 105 that were not selected.

Additionally, in some cases, there may be a load imbalance between candidate cells associated with candidate network entities 105 in the list. For example, a candidate cell may serve a large quantity of other UEs and may have limited resources available for the UE 115. The load imbalance may not be accounted for by cell-specific offsets, measurement object-specific offsets, hysteresis parameters, or other thresholds defined for the candidate cell which may be used by the UE 115 to select a target cell. Thus, in some cases, if the UE 115 selects the candidate cell as the target cell based on signal quality alone, the UE 115 may experience significant latency when trying to perform a random access procedure with the candidate cell due to the limited resources available at the target cell.

Further, the co-existence of multiple types of UE 115, such as reduced capability UEs 115 or non-reduced capability UEs 115, as well as different synchronization signal block (SSB) types, such as cell defining SSBs (CD-SSBs) and non-cell defining SSBs (NCD-SSBs), within the wireless communications system 100 may increase the complexity of measurements for conditional cell change procedures. For example, a source network entity 105 may configure a UE 115 to perform quality measurements associated with one or more candidate network entities 105 for a conditional cell change using an NCD-SSB. However, after selecting a target cell associated with a target network entity 105 from the one or more candidate network entities, the UE 115 may be configured to perform a random access procedure to the target network entity 105 using a CD-SSB. The resources (e.g., time or frequency resources) for the different types of SSBs may be different, which may result in different signal quality for the random access procedure than would have been expected based on the quality measurements. Thus, in some cases, the UE 115 may experience poor signal quality in communication with the target network entity 105, despite quality measurements indicating otherwise.

Therefore, aspects of the disclosure are directed to enhancements to conditional cell change procedures (e.g., conditional handover, conditional PSCell change) to improve communication efficiency and robustness. In accordance with examples described herein, a UE 115 may transmit UAI (e.g., a message including UAI) and a request for NAI (e.g., a message including a NAI request) to a source network entity 105. The UAI may contain information to assist the source network entity 105 in determining a list of candidate cells for a conditional cell change. For example, the UAI may include one or more parameters that are supported and/or preferred by the UE 115 for wireless communications, which may include one or more coverage enhancement schemes. The source network entity 105 may transmit (e.g., in a message containing NAI) an indication of the list of candidate cells, alongside other information that may be used by the UE 115 in determining a target cell. In some examples, the source network entity 105 may transmit a message including NAI that may indicate a time-dependency or a location-dependency for the list of candidate cells (e.g., as a bitmap). Additionally, or alternatively, the NAI may indicate that one or more candidate cells support early data forwarding, one or more coverage enhancements for the conditional cell change procedure, or both, among other examples.

For example, the UE 115 may support one or more coverage enhancement schemes, which may include dynamic switching of uplink waveforms towards a target cell, repetitions or frequency hopping towards the target cell, a maximum power reduction or a peak-to-average ratio reduction, dynamic switching of power control parameters for random access or uplink channels based on a dynamic power aggregation on uplink and a SAR compliance report of the UE 115, and dynamically scheduled reference signals for measurements. Similarly, one or more candidate cells may support one or more of these coverage enhancement schemes. In some examples, the UE 115 may indicate the source network entity 105 (e.g., in UAI) of one or more coverage enhancement schemes supported by the UE 115, and the source network entity 105 may include candidate cells that similarly support one or more of the coverage enhancement schemes supported by the UE 115 in the list of candidate cells.

Accordingly, the source network entity 105 may be provided with UAI from the UE 115, which may aid the source network entity 105 in selecting a list of candidate cells (e.g., based on one or more features preferred by the UE 115). Similarly, the UE 115 may select a target cell based on additional information indicated in NAI, such as support for one or more of the coverage enhancements described herein. This may result in increased reliability and efficiency in conditional cell change procedures.

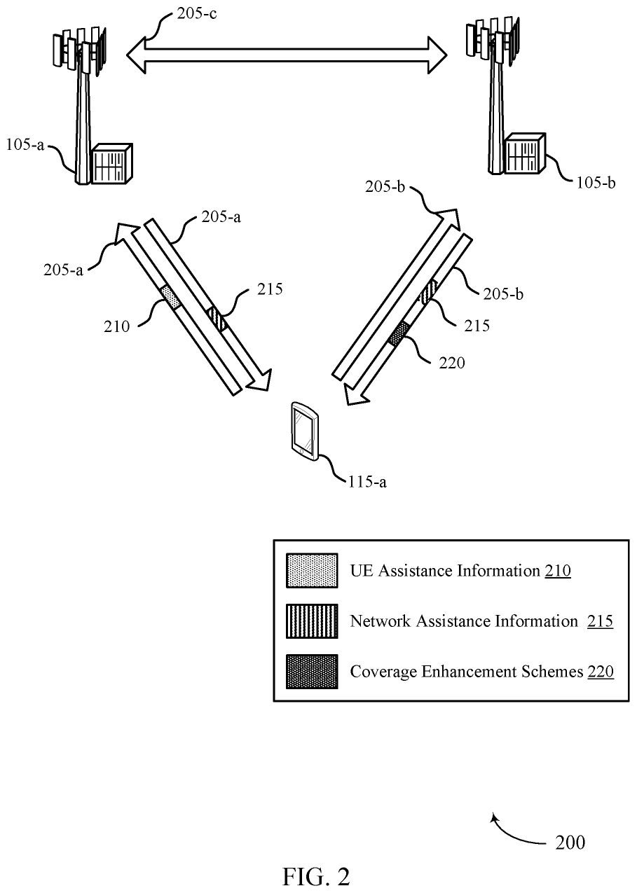

FIG. 2 illustrates an example of a wireless communications system 200 that supports techniques for enhancing conditional changes of a serving cell in accordance with one or more aspects of the present disclosure. The wireless communications system 200 may implement features of the wireless communications system 100 as described herein, with reference to FIG. 1. For example, the wireless communications system includes a UE 115-a, a network entity 105-a, and a network entity 105-b, which may be examples of corresponding devices described herein, for example, with reference to FIG. 1. Additionally, the UE 115-a, the network entity 105-a, and the network entity 105-b may communicate using various communication links, including communication link 205-a, communication link 205-b, and communication link 205-c, which may be examples of a communication link 125 or a backhaul communication link 120, as described herein with reference to FIG. 1. As an example, the UE 115-a and the network entity 105-a may communicate via communication link 205-a, the UE 115-a and the network entity 105-b may communicate using communication link 205-b, and the network entity 105-a and the network entity 105-b may communicate via communication link 205-c.

The wireless communications system 200 may support conditional serving cell change procedures (e.g., conditional handover procedures or conditional PSCell change procedures). For example, the network entity 105-a may be associated with a serving cell (e.g., a source cell) via which the UE 115-a is communicating. Further, the UE 115-a may be mobile or otherwise may be handed over (e.g., due to changing channel conditions) to another, different cell, for example, provided by the network entity 105-b using a conditional handover procedure. The UE 115-a may evaluate conditions (e.g., signal quality conditions) associated with the cell provided by the network entity 105-a (e.g., a serving cell, source cell, or PSCell), and if conditions (e.g., cell change conditions or constraints) are met, the UE 115-a may be triggered to perform a cell change the current cell to a target cell provided by the network entity 105-b. Conditional serving cell change procedures may face various challenges, however, particularly in view of new and emerging technologies.

For example, early data forwarding between network entities 105 may result in increased overhead and wasted transmission resources as a selected candidate network entity 105 may not support early data forwarding and a source network entity 105 may forward the UE data to candidate network entities 105 that were not selected. Additionally, there may be a load imbalances between candidate cells associated with candidate network entities 105, which may result in significant latency when trying to perform a random access procedure with the candidate cell due to limited resources available at a target cell. As an example, the target network entity 105-b may be located at or near a sporting event or metropolitan area where a relatively high quantity of UEs are concentrated. Further, the co-existence of multiple types of UE 115, such as reduced capability UEs 115 or non-reduced capability UEs 115, as well as different SSB types may increase the complexity of measurements for conditional serving cell change procedures. Accordingly, aspects described herein relate to improvements to conditional serving cell change procedures.

In accordance with examples described herein, the UE 115-a may transmit a message include UAI 210 to the network entity 105-a, which may be a source network entity 105 of the UE 115-a. In some examples, the UAI 210 may be or include a request for NAI 215 from the network entity 105-a. The request for NAI 215 may include a requests for a system loading status, a network energy serving status, a coverage enhancements available in candidate cells, or a combination thereof. Additionally, or alternatively, the request for the NAI 215 may include a request for a time or location dependent list of candidate cells (e.g., mapped to zones in a trajectory of the UE 115), which the UE 115-a may use to track identifiers (IDs) of candidate cells that are valid (e.g., within a time or location range) for cell change evaluation (e.g., to choose a target cell) as the UE 115-a moves. The request for the NAI 215 may include additional information related to conditional serving cell change procedures, such as whether a candidate cell supports early data forwarding (e.g., in contention-based random access (CBRA) or contention-free random access (CFRA) procedures).

In addition to the request for NAI 215, or alternatively, the UAI 210 may include an indication of a waveform that may be supported (e.g., or preferred) by the UE 115-a (e.g., discrete Fourier transform-spread orthogonal frequency division multiplexing (DST-s-OFDM) waveforms or cyclic prefix orthogonal frequency division multiplexing (CP-OFDM) waveforms), one or more coverage enhancement schemes supported by the UE 115-a, a buffer status report, a power headroom report, a power budget for power aggregation at the UE 115-a, an estimate of a location of the UE 115-a, an estimate of a velocity (e.g., a speed and a direction) of the UE 115-a, a report for a buffer status or a power headroom of the UE 115-a, an indication of one or more power saving configurations, a report of a capability of the UE 115-a associated with single-connectivity or multi-connectivity, or a combination thereof.

The network entity 105-a may use the information included in the UAI 210 to determine information related to a conditional serving cell change procedure, which may be indicated to the UE in the NAI 215. In some examples, the one or more coverage enhancement schemes may include a repetition scheme or a frequency hopping scheme for physical random access channel (PRACH) transmission, PUSCH transmissions, physical uplink control channel (PUCCH) transmissions, or any combination thereof. Additionally, or alternatively, the one or more coverage enhancement schemes may include transport block size (TBS) scaling factors for physical downlink shared channel (PDSCH) or PUSCH transmissions. The one or more coverage enhancements may also include demodulation reference signal (DMRS) bundling, lowering of a modulation order, lowering of a coding rate, slot or sub-slot aggregation, or a combination thereof, for a random access procedure associated with the cell selection. In further examples, the one or more coverage enhancement schemes may relate to coverage enhancement schemes presented in further detail herein. The network entity 105-a may, for example, select candidate cells based on the candidate cells supporting the coverage enhancement schemes that are indicated to be supported by the UE 115-a.

In some cases, using one or more coverage enhancement schemes may increase power consumption at the UE 115-a. Therefore, if the UE 115-a indicates a power saving configuration in the UAI 210, the network entity 105-a may choose coverage enhancement schemes in order to achieve a tradeoff between coverage enhancement and power saving at the UE 115-a. For example, the UE 115-a may choose coverage enhancement schemes that may maintain the power consumption at the UE 115-a below a threshold power value, which may be indicated by the UE 115-a.

In some examples, the power headroom report may be used by the network entity 105-a to aid in choosing a quantity of candidate cells for multi-connectivity situations. Multi-connectivity situations may refer to cases in which the UE 115-a may connect to multiple cells, relays, or repeaters, and may include carrier aggregation cases, dual connectivity cases, or sidelink cases. Meanwhile, single-connectivity situations may involve the UE 115-a connecting to a single serving cell at a time. The capability of the UE 115-a associated with single-connectivity or multi-connectivity may indicate the network entity 105-a whether the UE 115-a is able to support these connectivity scenarios (e.g., or a supported quantity of cells for multi-connectivity), and the network entity 105-a may select a quantity of candidate cells based on the indicated capability of the UE 115-a.

In some cases, the network entity 105-a may determine a data forwarding scheme based on the report for a buffer status contained in the UAI 210. That is, the network entity 105-a may determine a scheme for forwarding (e.g., early forwarding) of user data associated with the UE 115-a based on the report for the buffer status. Accordingly, the network entity 105-a may generate NAI 215 based on the UAI 210 received from the UE 115-a.

In some examples, the network entity 105-a may generate NAI 215 by receiving information from candidate network entities 105, such as network entity 105-b (e.g., via communication link 205-c). If the network entity 105-a collects information related to multiple candidate network entities 105, the network entity 105-a may jointly transmit the information in a message containing NAI 215 to the UE 115-a. Alternatively, the network entity 105-a may transmit multiple messages containing NAI 215 to the UE 115-a, and each message may contain information associated with one or more (e.g., different) network entities 105. The network entity 105-a may indicate the NAI 215 to the UE 115-a via a radio resource control (RRC) message (e.g., an RRCReconfiguration message). In some aspects, the NAI 215 may be additionally or alternatively transmitted to the UE 115-a by one or more target cells (e.g., from the network entity 105-b).

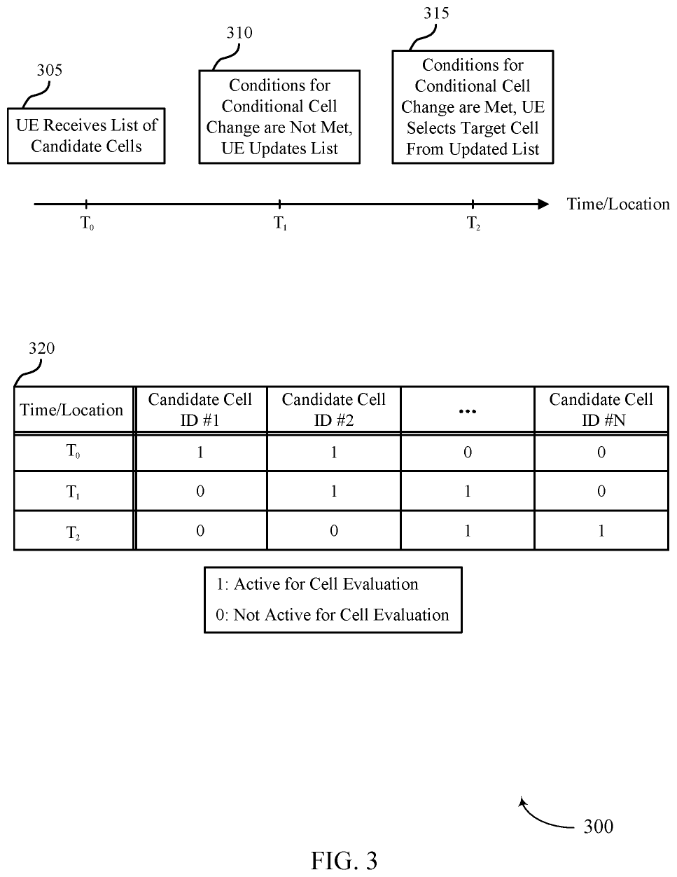

In some examples, the network entity 105-a may determine a list of candidate cells for the conditional change procedure based on the UAI 210 received from the UE 115-a. For example, the network entity 105-a may use location or velocity information of the UE 115-a to determine the list of candidate cells (e.g., cells that the UE 115-a may move towards in a future time). Additionally, or alternatively, the network entity 105-a may determine a time or location dependency for the list of candidate cells, which may be indicated via a bitmap, as described in more detail herein with reference to FIG. 3.

In some examples, the NAI 215 may include (e.g., in addition to the list of candidate cells) a quantity associated with a loading status of a candidate cell, an indication for a random access type for a candidate cell (e.g., CBRA, CFRA, 2-step random access, or 4-step random access), an indication of dynamic waveform switching (e.g., an indication that dynamic switching is enabled, supported by a candidate cell, or of a waveform), an indication that a candidate cell supports on or more coverage enhancements (e.g., in uplink, downlink, or both), an indication of an energy saving status of the network or of a candidate network entity 105, an indication of support for reception of early data forwarding by a candidate cell (e.g., via 2-step random access or 4-step random access), or a combination thereof.

In some examples, the network entity 105-a may transmit one or more messages containing the NAI 215 that includes information requested by the UE 115-a in the request for NAI 215, as described herein. Alternatively, the network entity 105-a may include information in the NAI 215 regardless of whether the information was requested by the UE 115-a or if a request for NAI 215 was received at all.

The UE 115-a may receive a message indicating the NAI 215 from the network entity 105-a, and the UE 115-a may select a candidate network entity 105 as a target network entity 105 for a conditional serving cell change procedure based on the received NAI 215. For example, the UE 115-a may store the list of candidate cells and perform measurements associated with one or more of the candidate cells in the list. The UE 115-a may evaluate conditions (e.g., signal quality or other conditions) associated with each of the candidate cells, and if cell change conditions are met, the UE 115-a may select a candidate cell (e.g., a candidate cell with a highest signal quality or that meets other constraints set by the UE 115-a or the network entity 105-a) as a target cell. For example, the UE 115-a may select a target cell associated with network entity 105-b, and may begin a random access procedure with the network entity 105-b.

In some cases, the UE 115-a may support modified evaluation conditions (e.g., entering or leaving conditions) for selecting a target cell from the list of candidate cells. If the source cell associated with the network entity 105-a is aware of a current system loading status of a candidate cell (e.g., at a beam or cell level), the source cell may be able to predict a system loading status at a time in the future (e.g., using machine learning or artificial intelligence techniques). Then, if the network entity 105-b forwards a request for a conditional change from the UE 115-a, an indication of UAI 210 from the UE 115-a, a request for NAI 215 from the UE 115-a, or a combination thereof, to the candidate cell, the source cell and the candidate cell may exchange one or more messages via the communication link 205-c. The candidate cell and the source cell may exchange including system loading information and may jointly determine modified evaluation conditions for the UE 115-a. The network entity 105-a may transmit signaling to the UE 115-a indicating the modified evaluation conditions via communication link 205-a. Alternatively, such as in cases in which the connection between the source cell and the UE 115-a is broken, an anchor cell (e.g., which may be a secondary cell) that is still connected to the UE 115-a may transmit an indication of the modified evaluation conditions.

In some examples, evaluation conditions (e.g., modified evaluation conditions) may include an offset value, a hysteresis value, or both, associated with a target cell (e.g., a potential target cell). For example, the source cell or the candidate cell may map a system loading status, a network energy saving status (e.g., an active status, light sleep status, or micro sleep status), one or more coverage enhancements, or a combination thereof, to the offset value or the hysteresis values. Evaluation conditions also include an entering condition (e.g., condition for selecting a candidate cell as a target cell), a leaving condition (e.g., a condition for avoiding a particular candidate cell), or both, for the UE 115-a to decide to select a candidate cell as the target cell or refrain from selecting the candidate cell as the target cell.

An entering condition may involve measurements values (e.g., filtered values of RSRP, RSRQ, or SINR measurements) performed by the UE 115-a on one or more reference signal associated with the potential target cell (e.g., the candidate cell) and the source cell, the offset values, and the hysteresis values. If the entering condition is met for a potential target cell, the UE 115-a may determine to select the potential target cell as the target cell for a conditional serving cell change. For example, an entering condition may be given by Formula 1 below, where M_{target} is a value associated with measurements of a reference signal from the potential target cell, O_{target} is an indicated offset value, Hys_{target} is an indicated hysteresis value, and M_{source} is a value associated with measurements of a reference signal from the source cell.

M_{target}+O_{target}−HYs_{target}>M_{source} (1)

Similarly, a leaving condition may also involve measurements values (e.g., filtered values of RSRP, RSRQ, or SINR measurements) performed by the UE 115-a on one or more reference signal associated with the potential target cell (e.g., the candidate cell) and the source cell, the offset values, and the hysteresis values. If the leaving condition is met for a potential target cell, the UE 115-a may determine to refrain from selecting the potential target cell as the target cell for a conditional serving cell change. For example, a leaving condition may be given by Formula 2 below.

M_{target}+O_{target}+HYs_{target}<M_{source} (2)

In some examples, the evaluation conditions may include one or more threshold values associated with a system loading status, a network energy serving status, a coverage enhancement associated with one or more candidate cells, or a combination thereof. The one or more threshold values may include an entering threshold value and an exiting threshold value associated with an entering condition and a leaving condition, respectively. For example, the UE 115-a may be indicated of an entering condition, so that if candidate cell does not meet the entering condition, the UE 115-a may refrain from selecting the candidate cell as the target cell. or the UE 115-a may remove the candidate cell from the list of candidate cells. The entering condition may be based on a minimum value of an offset value and a hysteresis value associated with a potential target cell, as shown in Formula 3 below, where Threshₑₙₜₑᵣ is an indicated entering threshold value.

min(O_{target}−HYs_{target})<Threshₑₙₜₑᵣ (3)

Additionally, or alternatively, a leaving condition may be used by the UE 115-a, so that if a candidate cell meets the leaving condition, the UE 115-a may refrain from selecting the candidate cell as the target cell. or the UE 115-a may remove the candidate cell from the list of candidate cells. The leaving condition may similarly be based on a minimum value of an offset value and a hysteresis value associated with a potential target cell, as shown in Formula 4 below, where Thresh, it is an indicated exiting threshold value.

min(O_{target}−Hys_{target})>Threshₑₙₜₑᵣ (4)

As such, the UE 115-a may select or refrain from selecting a candidate cell as the target cell based on network or cell conditions that may be mapped to the offset values or hysteresis values, in addition to values associated with measurements of reference signals. Therefore, the UE 115-a may make a more informed decision regarding selection of a target cell and may avoid issues caused by load imbalances at a potential target cell, for example.

In some examples, the UE 115-a may receive a message from the network entity 105-b indicating one or more coverage enhancement schemes 220 (e.g., coverage enhancement features, capabilities, configurations, or procedures) supported by the target cell or the network entity 105-b via communication link 205-b. In some examples, the UE 115-a may transmit a message indicating to the network entity 105-b that the UE 115-a has selected the target cell (e.g., associated with the network entity 105-b), and the network entity 105-b may transmit the message indicating the coverage enhancement schemes 220 in response. In some other examples, the network entity 105-b may transmit the message indicating the coverage enhancement schemes 220 without receiving a message from the UE 115-a.

The indication of one or more coverage enhancement schemes 220 supported by the target cell or the network entity 105-b may include support for dynamic switching of uplink waveforms. An indication of a supported waveform (e.g., uplink waveform) may involve indication of one or more supported waveform types, waveform formats, or waveform parameters such as subcarrier spacing, numerology, PAPR, or other parameters. For example, the network entity 105-b may indicate the UE 115-a of support for some waveforms, such as low peak-to-average power ratio (PAPR) waveforms, by the target cell.

In some examples, the indication of the one or more coverage enhancement schemes 220 may indicate support by the target cell for dynamic indications of repetitions or dynamic indications of frequency hopping, for example, for CBRA or CFRA procedures with the target cell or for physical downlink control channel (PDCCH) ordered 2-step random access or 4-step random access. Additionally, or alternatively, the network entity 105-b may indicate support by the target cell for joint indications of downlink or uplink coverage enhancements via downlink control information (DCI) or MAC-CE messages. Similarly, the network entity 105-b may indicate support by the target cell for joint indications of multiple uplink channels via DCI or MAC-CE messages, such as a dynamic indication of a PRACH, a PUSCH, and a PUCCH, a dynamic indication of a PRACH and a PUSCH, a dynamic indication of a PUSCH and a PUCCH, or other combinations of uplink channels.

In some examples, the network entity 105-b may indicate support by the target cell for dynamic indications of a maximum power reduction or a peak-to-average ratio reduction via DCI or MAC-CE messages. Additionally, or alternatively, the network entity 105-b may indicate support by the target cell for dynamic switching of power control parameters for random access or uplink channels based on a dynamic power aggregation on uplink and an SAR compliance report received from the UE 115-a. The power control parameters may be used by the UE 115-a to modify a transmit power for uplink transmissions or transmissions associated with the random access procedure.

The network entity 105-b may also indicate support for dynamic scheduling of an additional reference signal, such as a tracking reference signal (TRS), a positioning reference signal (PRS), an NCD-SSB, or another reference signal, or any combination thereof. The dynamic scheduling of an additional reference signal may enable distance-based cell selection or reselection at the UE 115-a.

In further examples, the coverage enhancement schemes 220 may include a repetition scheme or a frequency hopping scheme for PRACH, PUSCH, or PUCCH transmissions. Additionally, or alternatively, the coverage enhancement schemes 220 may include TBS scaling factors for PDSCH or PUSCH transmissions, DMRS bundling, lowering of a modulation order, lowering of a coding rate, slot or sub-slot aggregation, or a combination thereof, for a random access procedure associated with the cell selection. Accordingly, the UE 115-a may receive an indication of one or more coverage enhancement schemes 220 supported by the network entity 105-b.

The UE 115-a may initiate a random access procedure with the network entity 105-b based on the one or more coverage enhancement schemes 220 supported by the network entity 105-b (e.g., as indicated by the network entity 105-a or in NAI 215 by the network entity 105-b). For example, the UE 115-a may transmit or receive messages to or from the network entity 105-b in accordance with the repetitions scheme, the frequency hopping scheme, the demodulation reference signal bundling, the scaling of a transport block size (e.g., based on the scaling factors), the lowering of the modulation order, the lowering of the coding rate, the slot or sub-slot aggregation, or any combination thereof, supported by the network entity 105-b.

As such, the UE 115-a may support techniques for transmitting UAI 210 and requests for NAI 215 to the network entity 105-a, which may aid the network entity 105-a in providing NAI 215 to the UE 115-a. The UE 115-a may select a target cell based on the received NAI 215 and may perform random access procedures with the network entity 105-b associated with the target cell according to one or more coverage enhancement schemes 220 supported by the network entity 105-b or the target cell.

FIG. 3 illustrates an example of a cell evaluation process 300 that supports techniques for enhancing conditional changes of a serving cell in accordance with one or more aspects of the present disclosure. The cell evaluation process 300 may illustrate an example of a time dependency or a location dependency used for evaluating candidate cells, as described herein with reference to FIG. 2. Such time dependency or the location dependency for cell evaluation may be implemented at a UE 115, which may be an example of a UE 115 as described herein with reference to FIGS. 1 and 2. The cell evaluation process 300 illustrates procedures that may be performed by the UE 115 at respective instances (e.g., time T₀, time T₁, and time T₂), which may each correspond to a time or location of the UE 115.

In some examples, a UE 115 may receive an indication of a time dependency or a location dependency for a list of candidate cells for a conditional cell procedure. For example, the UE 115 may receive NAI from a network entity, as described in more detail herein with reference to FIG. 2. In some examples, the time dependency or location dependency may be generated by the network entity based on mobility information about the UE 115, which may be obtained from UAI received from the UE 115 or based on other information from the UE 115. The mobility information may include a position of the UE 115, a velocity (e.g., speed and direction) of the UE 115, a travel path of the UE 115, other mobility information, or a combination thereof.

For example, at 305, which may correspond to T₀, the UE 115 may receive a message indicating a list of candidate cells (e.g., candidate target cells) for a conditional serving cell change from a source cell. The UE 115 may be configured to evaluate the candidate cells contained in the list of candidate cells (e.g., at defined times or locations), and if some conditions are met, the UE 115 may select a candidate cell as a target cell for a conditional serving cell change. In some examples, the message may indicate a time dependency or a location dependency for the list of candidate cells, which may be in the form of a bitmap as illustrated by table 320. In some cases, a network entity may transmit the indication of the time dependency or location dependency based on a request by the UE 115 (e.g., in UAI or a request for NAI). Additionally, other NAI or modified conditions for conditional serving cell change evaluations may be indicated to the UE 115 by the network entity (e.g., at the request of the UE 115), as described in more detail herein with reference to FIG. 2.

At 310, which may correspond to T₁, the UE 115 may detect a zone change. For example, the UE 115 may detect that the UE 115 has moved to a location, area, or position associated with T₁. Alternatively, the UE 115 may determine that the current time matches a time associated with T₁ (e.g., by determining a time elapsed since T₀). The UE 115 may update the list of candidate cells according to the time dependency or location dependency. For example, the UE 115 may determine that a candidate cell with an ID value of 1 is not active (e.g., deactivated or suspended) for cell evaluation at T₁, as illustrated in table 320. Accordingly, the UE 115 may remove the candidate cell with the ID value of 1 from the list. The UE 115 may continue to update the list, and the UE 115 may add or remove other candidate cells from the list of candidate cells according to the time dependency or location dependency.

The UE 115 may evaluate candidate cells contained in the updated list of candidate cells. For example, the UE 115 may perform measurements associated with the candidate cells in the updated list of candidate cells. In some examples, and as illustrated in FIG. 3, the UE 115 may determine that the conditions for cell change are not met at T₁, and the UE 115 may refrain from performing a cell change.

At 315, which may correspond to T₂, the UE 115 may detect another zone change associated with T₂. The UE 115 may update the list of candidate cells again based on the time dependency or location dependency. For example, the UE 115 may determine that a candidate cell with an ID value of 2 is not active (e.g., deactivated or suspended) for cell evaluation at T₂, as illustrated in table 320, and remove the candidate cell with an ID value of 2 from the list of candidate cells. Similarly, the UE 115 may determine that a candidate cell with an ID value of N is active for cell evaluation, and the UE 115 may add the candidate cell with an ID value of N to the list of candidate cells.

The UE 115 may evaluate candidate cells contained in the updated list of candidate cells. For example, the UE 115 may perform measurements associated with the candidate cells in the updated list of candidate cells. In some examples, and as illustrated in FIG. 3, the UE 115 may determine that the conditions for cell change are met at T₂, and the UE 115 may perform a cell change. For example, the UE 115 may select the candidate cell with an ID value of N as a target cell, and may initiate a random access procedure, as described in more detail herein with reference to FIG. 2.

Accordingly, the UE 115 may perform target cell selection according to a time dependency or location dependency. This may reduce the overall measurements performed by the UE 115 at a given time or location, which may improve power savings at the UE 115 and reduce signaling overhead due to measurements.

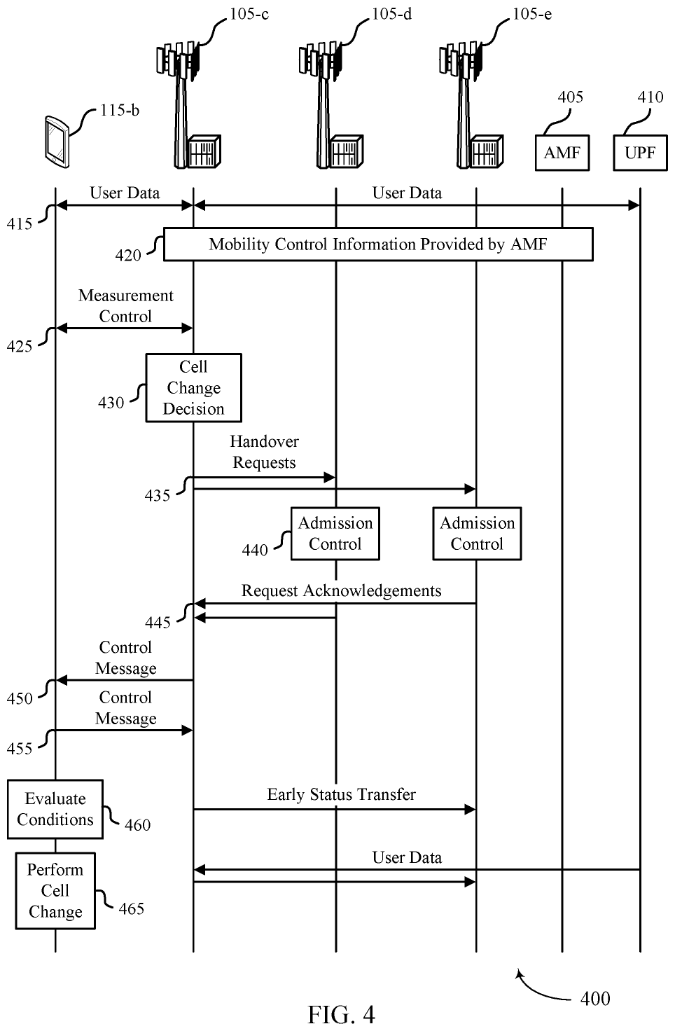

FIG. 4 illustrates an example of a process flow 400 that supports techniques for enhancing conditional changes of a serving cell in accordance with one or more aspects of the present disclosure. The process flow 400 may be implemented in a wireless communications system 100 or a wireless communications system 200 as described herein with reference to FIGS. 1 and 2. The process flow 400 may include a UE 115-b, a network entity 105-c, a network entity 105-d, and a network entity 105-e, which may be example of corresponding devices as described herein, for example, with reference to FIGS. 1 through 3. For example, the network entity 105-c may correspond to a source network entity 105, which may be associated with a source cell of the UE 115-b. Additionally, the network entity 105-d and the network entity 105-e may each be associated with a candidate cell (e.g., potential target cell). In some examples, the process flow 400 may include other network entities 105 associated with other candidate cells.

The process flow 400 may additionally include an AMF 405, which may be associated with mobility procedures, connection management, handovers procedures, and other procedures in a network. The process flow 400 may also include a UPF 410, which may be associated with processing network and user data, forwarding data, and packet processing, and other functions. In the following descriptions of the process flow 400, the operations performed by the devices may be performed in different orders or at different times. Additionally, or alternatively, some operations may be omitted from the process flow 400, and other operations may be added to the process flow 400.

At 415, the UE 115-b and the network entity 105-c may exchange data. For example, the UE 115-b may transmit one or more messages to the network entity 105-c containing user data. The network entity 105-c may relay (e.g., transmit, forward) user data received from the UE 115-b to the UPF 410. In some examples, the user data may be used in early data forwarding to a candidate cell for a conditional serving cell change.

At 420, the AMF 405 may provide mobility control information to the network entity 105-c, the network entity 105-d, and the network entity 105-e. The mobility control information may contain information related to roaming of the UEs 115 (e.g., such as UE 115-b), access restrictions, and other control information. The control information may be provided at a connection establishment with a UE 115, or during a tracking area update.

At 425, the UE 115-b and the network entity 105-c may exchange measurement control information associated with a conditional serving cell change. For example, the network entity 105-b may configure the UE 115-b with measurement procedures. The UE 115-b may perform measurements according to the measurement procedures, and the UE 115-b may provide one or more measurement reports to the network entity 105-b. In some examples, the UE 115-b may transmit one or more messages indicating UAI, a request for NAI, or both, as described in more detail herein, with reference to FIG. 2. In some cases, the UE 115-b may provide the UAI or the request for NAI at any point prior to performing a cell change (e.g., at 465).

At 430, the network entity 105-c may determine a conditional serving cell change decision. For example, the network entity 105-c may determine to initiate conditional serving cell change procedures based on information received from the UE 115-b, such as measurement reports, or requests from the UE 115-b, in accordance with measurement configurations (e.g., exchanged in the measurement control information). For example, measurement reports received from the UE 115-b may indicate the network entity 105-c that a signal quality associated with the source cell of the UE 115-b is relatively poor, and the network entity 105-c may decide to begin conditional serving cell change procedures.

At 435, the network entity 105-c may transmit one or more requests (e.g., handover requests) to the network entity 105-d and the network entity 105-e which may be associated with respective candidate cells.

At 440, the network entity 105-d and the network entity 105-e may perform admission control. Admission control may involve procedures to determine that resources are available to admit a UE 115 into a cell of the network entity 105-d or the network entity 105-e. In some examples, admission control may involve slice admission control (e.g., if slice information is sent to the network entity 105-d and the network entity 105-e).

At 445, the network entity 105-d and the network entity 105-e may transmit a request acknowledgment (e.g., a to the network entity 105-c. In some examples, the request acknowledgment may include a configuration of the candidate cell associated with the network entity 105-d or the network entity 105-e and may be sent for each candidate cell.

At 450, the network entity 105-c may transmit one or more control messages (e.g., RRCReconfiguration messages) to the UE 115-b. One or more of the control messages may contain configurations of the candidate cells associated with the network entity 105-d and the network entity 105-e. In some examples, one or more of the control messages may also contain execution conditions for the conditional serving cell change (e.g., conditions at which the UE 115-b will be triggered to perform a cell change).

In some examples, the network entity 105-c may additionally transmit one or more control messages to the UE 115-b containing NAI (e.g., in response to a request for NAI). For example, the network entity 105-c may transmit NAI indicating a list of candidate cells, a time or location dependency associated with the list of candidate cells, modified evaluation conditions, support for coverage enhancements by a candidate cell, and other assistance information that may be used by the UE 115-b to select a target cell, as described in more detail herein with reference to FIG. 2.

At 455, the UE 115-b may transmit a control message (e.g., an RRCReconfigurationComplete message) to the network entity 105-c. In some cases, the control message may acknowledge that the UE 115-b received the information transmitted by the network entity 105-c at 450.

At 460, the UE 115-b may evaluate conditions for the conditional serving cell change procedure. For example, the UE 115-b may determine that execution conditions for the conditional serving cell change are met and decide to initiate cell change procedures. The UE 115-b may perform measurements associated with one or more candidate cells indicated in the list of candidate cells, and the UE 115-b may select a target cell based on one or more evaluation conditions (e.g., indicated by the network entity 105-c). For example, the UE 115-b may select a candidate cell associated with the network entity 105-d as the target cell. These processes are described in more detail herein, with reference to FIGS. 2 and 3.

In some examples, if early data forwarding is indicated as allowed (e.g., active or applied), the network entity 105-c may transmit an early status transfer message to one or more network entities 105 associated with a candidate cell. For example, the network entity 105-c may transmit the early status transfer message to the network entity 105-e, which may indicate the network entity 105-e of an upcoming early data forward.

At 465, the UE 115-b may perform the cell change. For example, the UE 115-b may detach from the source cell and attach to the selected target cell. To attach to the selected target cell, the UE 115-b may initiate a random access procedure in accordance with NAI received from the network entity 105-c. For example, the UE 115-b may perform the random access procedure in accordance with one or more coverage enhancements supported by the target cell, as described herein with reference to FIG. 2. The network entity 105-c may forward data associated with the UE 115-b to one or more network entities 105. For example, the network entity 105-c may receive user data associated with the UE 115-b from the UPF 410, and the network entity 105-c may transmit the user data to the network entity 105-e.

Accordingly, the UE 115-b may support techniques for transmitting UAI and requests for NAI to the network entity 105-c, which may aid the network entity 105-c in providing NAI to the UE 115-b. The UE 115-b may select a target cell based on the received NAI, and the UE 115-b may perform random access procedures with the network entity 105-d associated with the target cell according to one or more coverage enhancements supported by the network entity 105-d or the target cell, as indicated in the NAI.

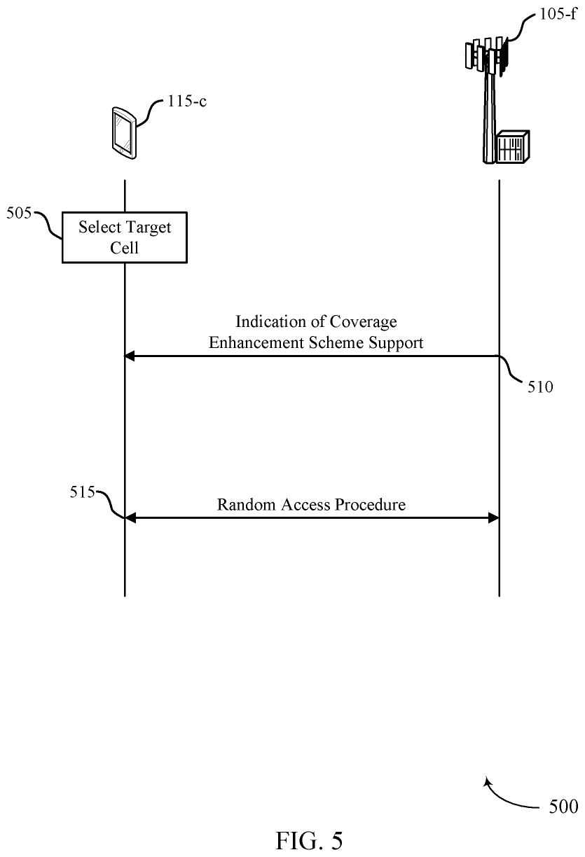

FIG. 5 illustrates an example of a process flow 500 that supports techniques for enhancing conditional changes of a serving cell in accordance with one or more aspects of the present disclosure. The process flow 500 may be implemented in a wireless communications system 100 or a wireless communications system 200 as described herein with reference to FIGS. 1 and 2. The process flow 500 may include a UE 115-c and a network entity 105-f, which may be an example of corresponding devices as described herein, for example, with reference to FIGS. 1 through 4. For example, the network entity 105-f may correspond to a target network entity 105, which may be associated with a target cell of the UE 115-c. In the following descriptions of the process flow 500, the operations performed by the devices may be performed in different orders or at different times. Additionally, or alternatively, some operations may be omitted from the process flow 500, and other operations may be added to the process flow 500.

At 505, the UE 115-c may select a target cell from a set of one or more candidate cells associated with a conditional serving cell change of a serving cell. For example, the UE 115-c may select a candidate cell associated with the network entity 105-f as a target cell.

At 510, the UE 115-c may receive a control message indicating one or more coverage enhancement schemes supported by the target cell from the network entity 105-f. In some cases, the UE 115-c may receive the control message from another network entity 105, such as a source network entity 105 (e.g., associated with a source cell of the UE 115-c) or an anchor network entity 105 (e.g., associated with an anchor cell of the UE 115-c).

In some examples, the control message may indicate that the target cell supports dynamic switching of an uplink waveform for the signaling that is part of a random access procedure for the conditional serving cell change. Accordingly, the UE 115-c may receive a message via DCI, MAC-CE, or RRC, for example, that indicates an uplink waveform supported by the target cell, as described in more detail herein, with reference to FIG. 2.

In some examples, the control message may indicate that the target cell supports repetitions, frequency hopping, demodulation reference signal bundling, scaling of a transport block size, lowering of a modulation order, lowering of a coding rate, slot or sub-slot aggregation, or any combination thereof, for the signaling that is part of the random access procedure, as described in more detail herein, with reference to FIG. 2.

In some examples, the control message may indicate that the target cell supports a maximum power reduction, peak-to-average power reduction, or both. Additionally, or alternatively, the control message may indicate the UE 115-c that the target cell supports modification of one or more power control parameters, as described in more detail herein, with reference to FIG. 2.

In some examples, the control message may indicate that the target cell supports scheduling of one or more additional reference signals that may enable distance-based cell selection or reselection procedures at the UE 115-c. Details regarding the scheduling of additional reference signals are described in more detail herein, with reference to FIG. 2.

In some cases, the UE 115-c may transmit a capability message to the network entity 105-f that indicates one or more coverage enhancement schemes supported by the UE 115-c. The network entity 105-f may transmit the control message indicating the one or more coverage enhancement schemes based on receiving the capability message from the UE 115-c. For example, the network entity 105-f may indicate the UE 115-c of one or more coverage enhancement schemes supported by the target cell that are also supported by the UE 115-c, which may avoid unnecessary signaling of unsupported coverage enhancement schemes.

At 515, the UE 115-c may perform a random access procedure with the network entity 105-f for the conditional change of the serving cell, the random access procedure based on the one or more coverage enhancement schemes supported by the target cell. In some examples, the UE 115-c may modify a waveform of one or more uplink messages for the random access procedure to the network entity 105-f in accordance with an uplink waveform which the network entity 105-f indicated as supported by the target cell, as described in more detail herein, with reference to FIG. 2.

In some examples, the UE 115-c may perform the random access procedure in accordance with repetitions, frequency hopping, demodulation reference signal bundling, scaling of a transport block size, lowering of a modulation order, lowering of a coding rate, slot or sub-slot aggregation, or any combination thereof, that are indicated by the network entity 105-f as supported by the target cell.

In some examples, the UE 115-c may perform the random access procedure using the maximum power reduction, peak-to-average power reduction, or both, that were indicated by the network entity 105-c as supported by the target cell. Additionally, or alternatively, the UE 115-c may perform the random access procedure according to one or more modified power control parameters supported by the target cell, as described in more detail herein, with reference to FIG. 2. For example, the UE 115-c may modify one or more power control parameters according to an uplink power aggregation, a specific absorption rate at the UE 115-c, or both, as indicated by the network entity 105-f as supported by the target cell.

In some examples, the UE 115-c may measure one or more additional reference signals from the target cell to perform one or more distance-based cell selection or reselection procedures. For example, the UE 115-c may receive an indication of one or more additional reference signals from the network entity 105-f, and the UE 115-c may measure the one or more additional reference signals for the one or more distance-based cell selection or reselection procedures.

Accordingly, the UE 115-c may connect to a target cell according to one or more coverage enhancement schemes, which may increase communication reliability and robustness.

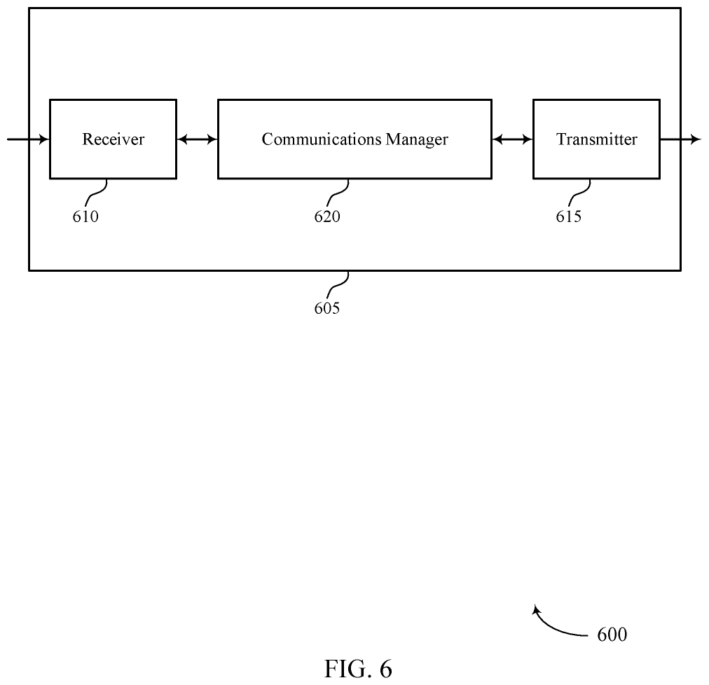

FIG. 6 illustrates a block diagram 600 of a device 605 that supports techniques for enhancing conditional changes of a serving cell in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for enhancing conditional changes of a serving cell). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for enhancing conditional changes of a serving cell). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for enhancing conditional changes of a serving cell as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for transmitting, to a network entity associated with a serving cell, a message indicating UAI for a conditional change of the serving cell, a request for NAI for the conditional change of the serving cell, or both. The communications manager 620 may be configured as or otherwise support a means for receiving, from the network entity, a control message that indicates a set of candidate cells for the conditional change of the serving cell. The communications manager 620 may be configured as or otherwise support a means for performing the conditional change of the serving cell to a target cell of the set of candidate cells based on the NAI and on one or more conditions being satisfied for the conditional change of the serving cell.

Additionally, or alternatively, the communications manager 620 may support wireless communication at a UE in accordance with examples as disclosed herein. For example, the communications manager 620 may be configured as or otherwise support a means for selecting a target cell from a set of one or more candidate cells for a conditional change of a serving cell. The communications manager 620 may be configured as or otherwise support a means for receiving, from a network entity associated with the target cell, a control message indicating one or more coverage enhancement schemes supported by the target cell. The communications manager 620 may be configured as or otherwise support a means for performing a random access procedure with the network entity based on the conditional change of the serving cell, where signaling that is part of the random access procedure is based on the one or more coverage enhancement schemes supported by the target cell.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for conditional serving cell change procedures using reduced processing and with increased communication efficiency and robustness.

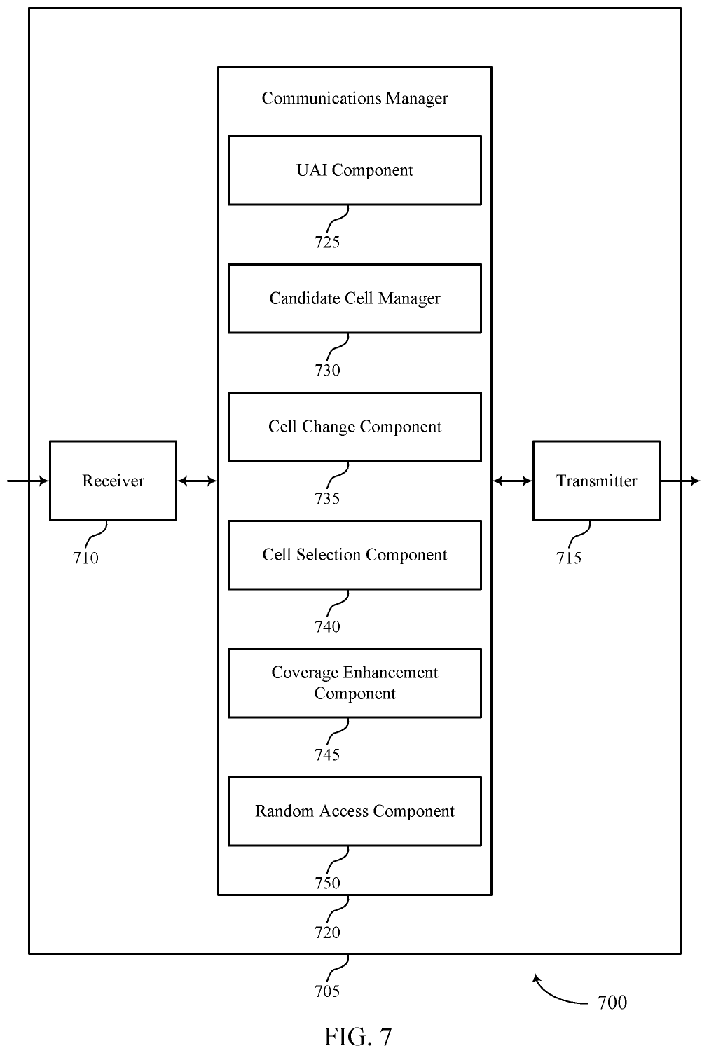

FIG. 7 illustrates a block diagram 700 of a device 705 that supports techniques for enhancing conditional changes of a serving cell in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for enhancing conditional changes of a serving cell). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for enhancing conditional changes of a serving cell). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for enhancing conditional changes of a serving cell as described herein. For example, the communications manager 720 may include a UAI component 725, a candidate cell manager 730, a cell change component 735, a cell selection component 740, a coverage enhancement component 745, a random access component 750, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The UAI component 725 may be configured as or otherwise support a means for transmitting, to a network entity associated with a serving cell, a message indicating UAI for a conditional change of the serving cell, a request for NAI for the conditional change of the serving cell, or both. The candidate cell manager 730 may be configured as or otherwise support a means for receiving, from the network entity, a control message that indicates a set of candidate cells for the conditional change of the serving cell. The cell change component 735 may be configured as or otherwise support a means for performing the conditional change of the serving cell to a target cell of the set of candidate cells based on the NAI and on one or more conditions being satisfied for the conditional change of the serving cell.

Additionally, or alternatively, the communications manager 720 may support wireless communication at a UE in accordance with examples as disclosed herein. The cell selection component 740 may be configured as or otherwise support a means for selecting a target cell from a set of one or more candidate cells for a conditional change of a serving cell. The coverage enhancement component 745 may be configured as or otherwise support a means for receiving, from a network entity associated with the target cell, a control message indicating one or more coverage enhancement schemes supported by the target cell. The random access component 750 may be configured as or otherwise support a means for performing a random access procedure with the network entity based on the conditional change of the serving cell, where signaling that is part of the random access procedure is based on the one or more coverage enhancement schemes supported by the target cell.

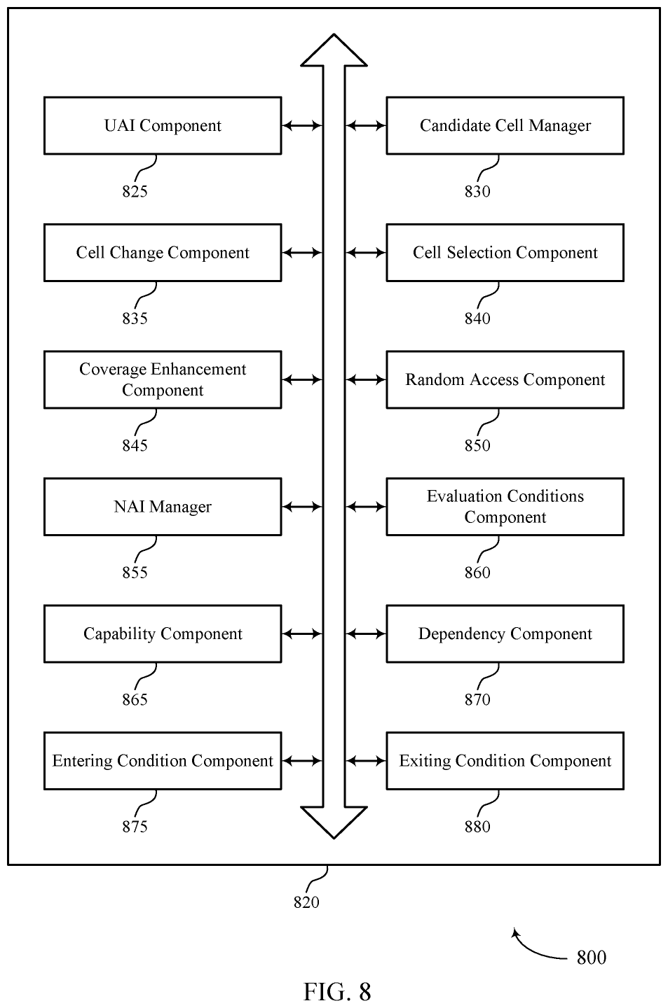

FIG. 8 illustrates a block diagram 800 of a communications manager 820 that supports techniques for enhancing conditional changes of a serving cell in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for enhancing conditional changes of a serving cell as described herein. For example, the communications manager 820 may include a UAI component 825, a candidate cell manager 830, a cell change component 835, a cell selection component 840, a coverage enhancement component 845, a random access component 850, a NAI manager 855, an evaluation conditions component 860, a capability component 865, a dependency component 870, an entering condition component 875, an exiting condition component 880, or any combination thereof. Each of these components may communicate, directly or indirectly, with one another (e.g., via one or more buses).

The communications manager 820 may support wireless communication at a UE in accordance with examples as disclosed herein. The UAI component 825 may be configured as or otherwise support a means for transmitting, to a network entity associated with a serving cell, a message indicating UAI for a conditional change of the serving cell, a request for NAI for the conditional change of the serving cell, or both. The candidate cell manager 830 may be configured as or otherwise support a means for receiving, from the network entity, a control message that indicates a set of candidate cells for the conditional change of the serving cell. The cell change component 835 may be configured as or otherwise support a means for performing the conditional change of the serving cell to a target cell of the set of candidate cells based on the NAI and on one or more conditions being satisfied for the conditional change of the serving cell.

In some examples, the UAI indicates one or more coverage enhancement schemes supported by the UE. In some examples, the control message includes the NAI in response to the UAI and the request, the NAI being associated with at least one candidate cell of the set of candidate cells that support at least one of the one or more coverage enhancement schemes supported by the UE for downlink transmissions or uplink transmissions.

In some examples, the NAI includes a loading status of one or more candidate cells of the set of candidate cells, a random access type associated with the one or more candidate cells, an indication of whether the one or more candidate cells support dynamic waveform switching, an indication of whether the one or more candidate cells support one or more coverage enhancement schemes, an indication of an energy saving status associated with each network entity providing the one or more candidate cells, an indication of whether the one or more candidate cells support data forwarding, or any combination thereof.

In some examples, the NAI comprises an indication of a time-dependency associated with the set of candidate cells, a location-dependency associated with the set of candidate cells, or both, and the dependency component 870 may be configured as or otherwise support a means for evaluating the one or more conditions for the conditional change of the serving cell based on the time-dependency, the location-dependency, or both, where the evaluating is performed at respective times, at respective locations of the UE, or both. In some examples, the dependency component 870 may be configured as or otherwise support a means for modifying the set of candidate cells for evaluation in response to the one or more conditions failing to be satisfied for the conditional change of the serving cell based on the evaluating, where the modified set of candidate cells includes one or more candidate cells activated for evaluation, one or more candidate cells removed from evaluation, or both.

In some examples, the UAI further indicates the request for the NAI, and the NAI manager 855 may be configured as or otherwise support a means for receiving, from the network entity or a candidate cell of the set of candidate cells, one or more messages indicating the NAI in response to the request, the NAI being associated with at least one candidate cell of the set of candidate cells, where performing the conditional change of the serving cell is based on receiving the NAI.

In some examples, the evaluation conditions component 860 may be configured as or otherwise support a means for determining an offset value, or a hysteresis value, or both, for each candidate cell of the set of candidate cells, where each offset value, or each hysteresis value, or both, is mapped to a system loading status of a candidate cell, a network energy saving status of the candidate cell, one or more coverage enhancement schemes supported by the candidate cell, or any combination thereof. In some examples, the evaluation conditions component 860 may be configured as or otherwise support a means for performing measurements of signals associated with respective candidate cells of the set of candidate cells and signals associated with the serving cell. In some examples, the evaluation conditions component 860 may be configured as or otherwise support a means for evaluating each candidate cell of the set of candidate cells for the conditional change of the serving cell based on the measurements, the offset value, or the hysteresis value, or any combination thereof.

In some examples, the entering condition component 875 may be configured as or otherwise support a means for selecting the target cell from the set of candidate cells based on a sum of a measurement value for the target cell, an offset value for the target cell, and a hysteresis value for the target cell being greater than a measurement value for the serving cell.

In some examples, the exiting condition component 880 may be configured as or otherwise support a means for refraining from selecting a second candidate cell from the set of candidate cells based on a sum of a measurement value for the second candidate cell, an offset value for the second candidate cell, and a hysteresis value for the second candidate cell being less than a measurement value for the serving cell.

In some examples, the evaluation conditions component 860 may be configured as or otherwise support a means for determining a set of thresholds for the conditional change of the serving cell, each threshold of the set of thresholds corresponding to the system loading status of a candidate cell, the network energy saving status of the candidate cell, one or more coverage enhancement schemes supported by the candidate cell, or any combination thereof, where each candidate the set of candidate cells is evaluated based on the set of thresholds, the offset value, and the hysteresis value.

In some examples, the entering condition component 875 may be configured as or otherwise support a means for selecting the target cell from the set of candidate cells based on a minimum of an offset value for the target cell and a hysteresis value for the target cell being less than a threshold value from the set of thresholds.

In some examples, the exiting condition component 880 may be configured as or otherwise support a means for refraining from selecting a second candidate cell from the set of candidate cells based on a minimum of an offset value for the second candidate cell and a hysteresis value for the second candidate cell being greater than a threshold value from the set of thresholds.

In some examples, the control message further indicates the set of candidate cells and a first configuration of the one or more conditions for performing the conditional change of the serving cell, and the evaluation conditions component 860 may be configured as or otherwise support a means for receiving a second control message indicating a second configuration of the one or more conditions, where performing the conditional change of the serving cell to the target cell is based on the second configuration of the one or more conditions.

In some examples, the UAI includes an indication of a preferred waveform, one or more coverage enhancement schemes supported by the UE, a buffer status report, a power headroom report, a preferred power budget for power aggregation at the UE, an estimate of a location of the UE, an estimate of a velocity of the UE, a report for a buffer status or a power headroom of the UE, an indication of one or more power saving configurations, a report of a capability of the UE associated with single-connectivity or multi-connectivity, or any combination thereof.

Additionally, or alternatively, the communications manager 820 may support wireless communication at a UE in accordance with examples as disclosed herein. The cell selection component 840 may be configured as or otherwise support a means for selecting a target cell from a set of one or more candidate cells for a conditional change of a serving cell. The coverage enhancement component 845 may be configured as or otherwise support a means for receiving, from a network entity associated with the target cell, a control message indicating one or more coverage enhancement schemes supported by the target cell. The random access component 850 may be configured as or otherwise support a means for performing a random access procedure with the network entity based on the conditional change of the serving cell, where signaling that is part of the random access procedure is based on the one or more coverage enhancement schemes supported by the target cell.

In some examples, to support receiving the control message indicating the one or more coverage enhancement schemes supported by the target cell, the coverage enhancement component 845 may be configured as or otherwise support a means for receiving the control message indicating that the target cell supports dynamic switching of an uplink waveform for the signaling that is part of the random access procedure. In some examples, to support receiving the control message indicating the one or more coverage enhancement schemes supported by the target cell, the coverage enhancement component 845 may be configured as or otherwise support a means for receiving a message indicating an uplink waveform supported by the target cell, the message including a DCI message, a MAC-CE message, or a RRC message. In some examples, to support receiving the control message indicating the one or more coverage enhancement schemes supported by the target cell, the coverage enhancement component 845 may be configured as or otherwise support a means for modifying a waveform of one or more uplink messages to the network entity for the random access procedure based on the target cell supporting the dynamic switching of the uplink waveform and receiving the message indicating the uplink waveform.

In some examples, to support receiving the control message indicating the one or more coverage enhancement schemes supported by the target cell, the coverage enhancement component 845 may be configured as or otherwise support a means for receiving the control message indicating that the target cell supports repetitions, frequency hopping, demodulation reference signal bundling, scaling of a transport block size, lowering of a modulation order, lowering of a coding rate, slot or sub-slot aggregation, or any combination thereof, for the signaling that is part of the random access procedure. In some examples, to support receiving the control message indicating the one or more coverage enhancement schemes supported by the target cell, the coverage enhancement component 845 may be configured as or otherwise support a means for transmitting or receiving, for the random access procedure, one or more messages to the network entity or from the network entity based on receiving the control message and according to the repetitions, the frequency hopping, the demodulation reference signal bundling, the scaling of the transport block size, the lowering of the modulation order, the lowering of the coding rate, the slot or sub-slot aggregation, or the combination thereof.

In some examples, to support receiving the control message indicating the one or more coverage enhancement schemes supported by the target cell, the coverage enhancement component 845 may be configured as or otherwise support a means for receiving the control message indicating that the target cell supports maximum power reduction, or peak-to-average power ratio reduction, or both. In some examples, to support receiving the control message indicating the one or more coverage enhancement schemes supported by the target cell, the coverage enhancement component 845 may be configured as or otherwise support a means for transmitting one or more messages to the network entity using the maximum power reduction, or peak-to-average power ratio reduction, or both.

In some examples, to support receiving the control message indicating the one or more coverage enhancement schemes supported by the target cell, the coverage enhancement component 845 may be configured as or otherwise support a means for receiving the control message indicating that the target cell supports modification of one or more power control parameters for uplink messages to the network entity. In some examples, to support receiving the control message indicating the one or more coverage enhancement schemes supported by the target cell, the coverage enhancement component 845 may be configured as or otherwise support a means for transmitting one or more messages to the network entity based on modifying the one or more power control parameters, where the one or more power control parameters are modified based on uplink power aggregation and a specific absorption rate at the UE.

In some examples, to support receiving the control message indicating the one or more coverage enhancement schemes supported by the target cell, the coverage enhancement component 845 may be configured as or otherwise support a means for receiving the control message indicating that the target cell supports scheduling of one or more reference signals that are associated with distance-based cell selection procedures. In some examples, to support receiving the control message indicating the one or more coverage enhancement schemes supported by the target cell, the coverage enhancement component 845 may be configured as or otherwise support a means for measuring the one or more reference signals from the target cell for one or more distance-based cell selection procedures.

In some examples, the capability component 865 may be configured as or otherwise support a means for transmitting a capability message indicating a capability of the UE to support the one or more coverage enhancement schemes, where receiving the control message indicating the one or more coverage enhancement schemes supported by the target cell is based on the capability of the UE to support the one or more coverage enhancement schemes.

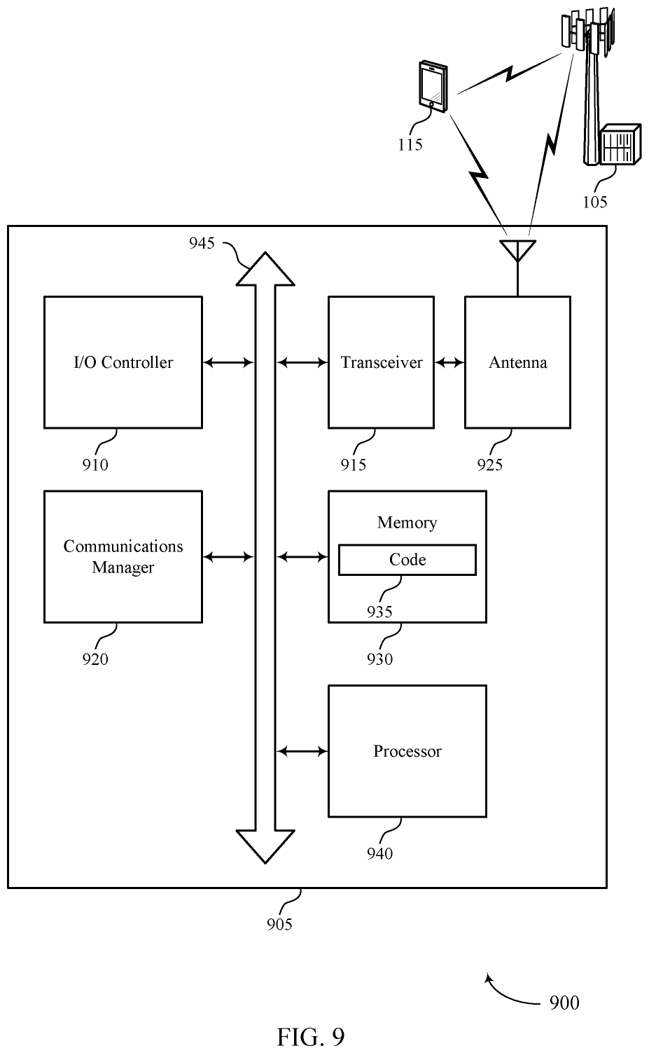

FIG. 9 illustrates a diagram of a system 900 including a device 905 that supports techniques for enhancing conditional changes of a serving cell in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable (e.g., processor-readable), computer-executable (e.g., processor-executable) code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for enhancing conditional changes of a serving cell). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for transmitting, to a network entity associated with a serving cell, a message indicating UAI for a conditional change of the serving cell, a request for NAI for the conditional change of the serving cell, or both. The communications manager 920 may be configured as or otherwise support a means for receiving, from the network entity, a control message that indicates a set of candidate cells for the conditional change of the serving cell. The communications manager 920 may be configured as or otherwise support a means for performing the conditional change of the serving cell to a target cell of the set of candidate cells based on the NAI and on one or more conditions being satisfied for the conditional change of the serving cell.

Additionally, or alternatively, the communications manager 920 may support wireless communication at a UE in accordance with examples as disclosed herein. For example, the communications manager 920 may be configured as or otherwise support a means for selecting a target cell from a set of one or more candidate cells for a conditional change of a serving cell. The communications manager 920 may be configured as or otherwise support a means for receiving, from a network entity associated with the target cell, a control message indicating one or more coverage enhancement schemes supported by the target cell. The communications manager 920 may be configured as or otherwise support a means for performing a random access procedure with the network entity based on the conditional change of the serving cell, where signaling that is part of the random access procedure is based on the one or more coverage enhancement schemes supported by the target cell.

By including or configuring the communications manager 920 in accordance with examples as described herein, the device 905 may support techniques for conditional serving cell change procedures using reduced processing and with increased communication efficiency and robustness, which may improve user experience via longer battery life and improved reliability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for enhancing conditional changes of a serving cell as described herein, or the processor 940 and the memory 930 may be otherwise configured to perform or support such operations.

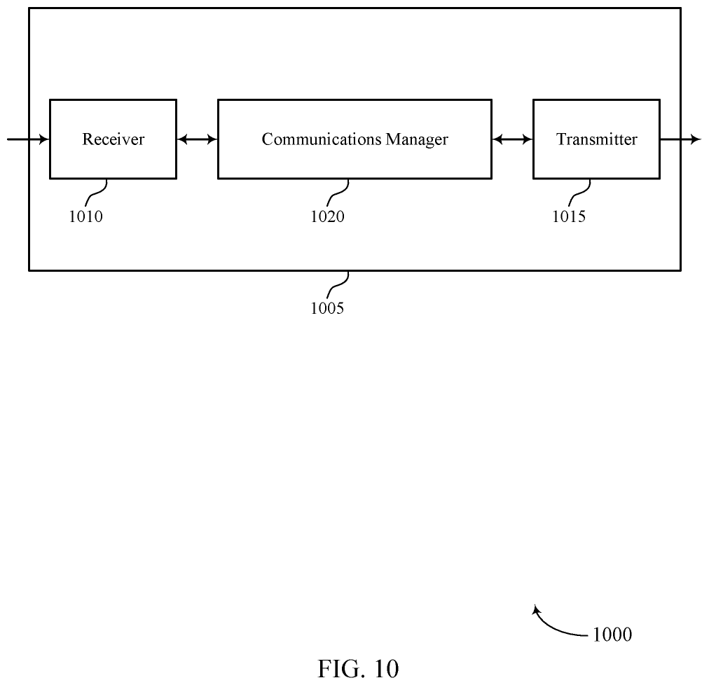

FIG. 10 illustrates a block diagram 1000 of a device 1005 that supports techniques for enhancing conditional changes of a serving cell in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., UQ samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for enhancing conditional changes of a serving cell as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for receiving, from a UE, a message indicating UAI for a conditional change of a serving cell, a request for NAI for the conditional change of the serving cell, or both. The communications manager 1020 may be configured as or otherwise support a means for transmitting, to the UE, a control message that indicates a set of candidate cells for the conditional change of the serving cell.

Additionally, or alternatively, the communications manager 1020 may support wireless communication at a network entity in accordance with examples as disclosed herein. For example, the communications manager 1020 may be configured as or otherwise support a means for receiving a message indicating that a UE has selected a target cell associated with the network entity for a conditional change of a serving cell. The communications manager 1020 may be configured as or otherwise support a means for transmitting, to the UE and based on receiving the message, a control message indicating one or more coverage enhancement schemes supported by the target cell. The communications manager 1020 may be configured as or otherwise support a means for performing a random access procedure with the UE based on the conditional change of the serving cell, where signaling that is part of the random access procedure is based on the one or more coverage enhancement schemes supported by the target cell.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for conditional serving cell change procedures using reduced processing and with increased communication efficiency and robustness.

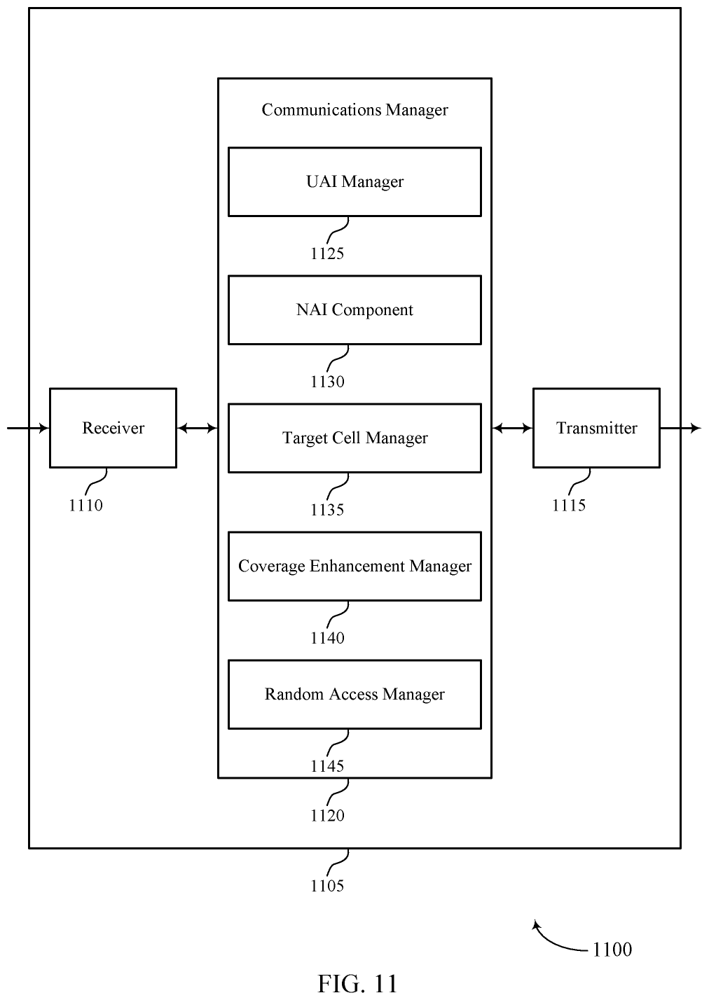

FIG. 11 illustrates a block diagram 1100 of a device 1105 that supports techniques for enhancing conditional changes of a serving cell in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., UQ samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., UQ samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for enhancing conditional changes of a serving cell as described herein. For example, the communications manager 1120 may include a UAI manager 1125, a NAI component 1130, a target cell manager 1135, a coverage enhancement manager 1140, a random access manager 1145, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The UAI manager 1125 may be configured as or otherwise support a means for receiving, from a UE, a message indicating UAI for a conditional change of a serving cell, a request for NAI for the conditional change of the serving cell, or both. The NAI component 1130 may be configured as or otherwise support a means for transmitting, to the UE, a control message that indicates a set of candidate cells for the conditional change of the serving cell.

Additionally, or alternatively, the communications manager 1120 may support wireless communication at a network entity in accordance with examples as disclosed herein. The target cell manager 1135 may be configured as or otherwise support a means for receiving a message indicating that a UE has selected a target cell associated with the network entity for a conditional change of a serving cell. The coverage enhancement manager 1140 may be configured as or otherwise support a means for transmitting, to the UE and based on receiving the message, a control message indicating one or more coverage enhancement schemes supported by the target cell. The random access manager 1145 may be configured as or otherwise support a means for performing a random access procedure with the UE based on the conditional change of the serving cell, where signaling that is part of the random access procedure is based on the one or more coverage enhancement schemes supported by the target cell.

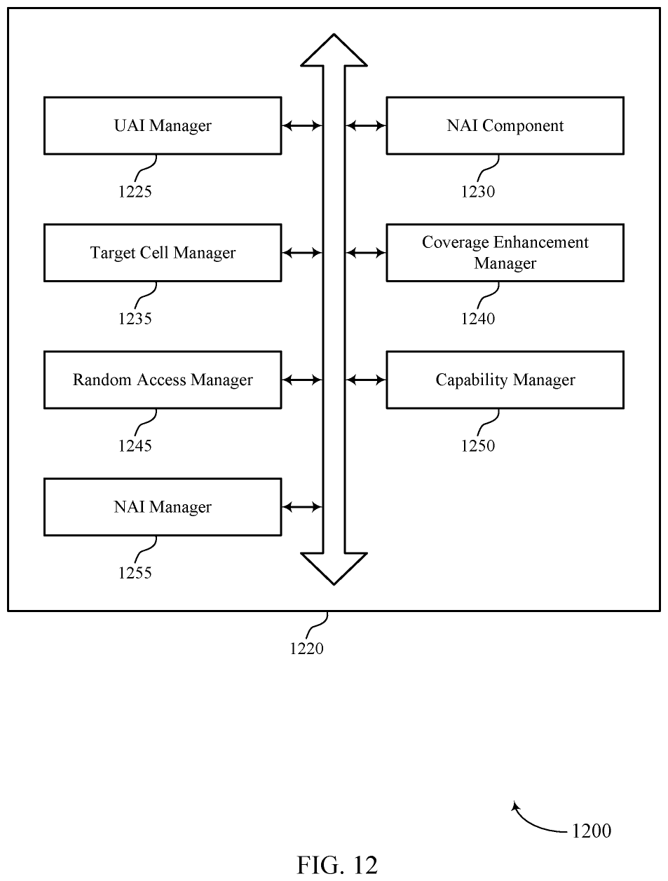

FIG. 12 illustrates a block diagram 1200 of a communications manager 1220 that supports techniques for enhancing conditional changes of a serving cell in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for enhancing conditional changes of a serving cell as described herein. For example, the communications manager 1220 may include a UAI manager 1225, a NAI component 1230, a target cell manager 1235, a coverage enhancement manager 1240, a random access manager 1245, a capability manager 1250, a NAI manager 1255, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The UAI manager 1225 may be configured as or otherwise support a means for receiving, from a UE, a message indicating UAI for a conditional change of a serving cell, a request for NAI for the conditional change of the serving cell, or both. The NAI component 1230 may be configured as or otherwise support a means for transmitting, to the UE, a control message that indicates a set of candidate cells for the conditional change of the serving cell.

In some examples, the UAI indicates one or more coverage enhancement schemes supported by the UE. In some examples, the control message includes the NAI in response to the UAI and the request, the NAI being associated with at least one candidate cell of the set of candidate cells that support at least one of the one or more coverage enhancement schemes supported by the UE for downlink transmissions or uplink transmissions.

In some examples, the NAI component 1230 may be configured as or otherwise support a means for transmitting the request for the NAI to each network entity associated with respective candidate cells of the set of candidate cells. In some examples, the NAI manager 1255 may be configured as or otherwise support a means for receiving the NAI for the respective candidate cells in response to the request for the NAI, where the NAI includes the NAI for the respective candidate cells.

In some examples, the NAI includes a loading status of one or more candidate cells of the set of candidate cells, a random access type associated with the one or more candidate cells, an indication of whether the one or more candidate cells support dynamic waveform switching, an indication of whether the one or more candidate cells support one or more coverage enhancement schemes, an indication of an energy saving status associated with each network entity providing the one or more candidate cells, an indication of whether the one or more candidate cells support data forwarding, or any combination thereof.

In some examples, the NAI includes an indication of a time-dependency associated with the set of candidate cells, a location-dependency associated with the set of candidate cells, or both.

In some examples, the UAI indicates the request for the NAI, and the NAI component 1230 may be configured as or otherwise support a means for transmitting, to the UE, one or more messages indicating the NAI in response to the request, the NAI being associated with at least one candidate cell of the set of candidate cells.

In some examples, the UAI includes an indication of a preferred waveform, one or more coverage enhancement schemes supported by the UE, a buffer status report, a power headroom report, a preferred power budget for power aggregation at the UE, an estimate of a location of the UE, an estimate of a velocity of the UE, a report for a buffer status or a power headroom of the UE, an indication of one or more power saving configurations, a report of a capability of the UE associated with single-connectivity or multi-connectivity, or any combination thereof.

Additionally, or alternatively, the communications manager 1220 may support wireless communication at a network entity in accordance with examples as disclosed herein. The target cell manager 1235 may be configured as or otherwise support a means for receiving a message indicating that a UE has selected a target cell associated with the network entity for a conditional change of a serving cell. The coverage enhancement manager 1240 may be configured as or otherwise support a means for transmitting, to the UE and based on receiving the message, a control message indicating one or more coverage enhancement schemes supported by the target cell. The random access manager 1245 may be configured as or otherwise support a means for performing a random access procedure with the UE based on the conditional change of the serving cell, where signaling that is part of the random access procedure is based on the one or more coverage enhancement schemes supported by the target cell.

In some examples, to support transmitting the control message indicating the one or more coverage enhancement schemes supported by the target cell, the coverage enhancement manager 1240 may be configured as or otherwise support a means for transmitting the control message indicating that the target cell supports dynamic switching of an uplink waveform for the signaling that is part of the random access procedure, where one or more uplink messages from the UE for the random access procedure have a modified waveform based on the target cell supporting the dynamic switching of the uplink waveform.

In some examples, to support transmitting the control message indicating the one or more coverage enhancement schemes supported by the target cell, the coverage enhancement manager 1240 may be configured as or otherwise support a means for transmitting the control message indicating that the target cell supports repetitions, frequency hopping, demodulation reference signal bundling, scaling of a transport block size, lowering of a modulation order, lowering of a coding rate, slot or sub-slot aggregation, or any combination thereof, for the signaling that is part of the random access procedure. In some examples, to support transmitting the control message indicating the one or more coverage enhancement schemes supported by the target cell, the coverage enhancement manager 1240 may be configured as or otherwise support a means for receiving or transmitting, for the random access procedure, one or more messages from the UE or to the UE based on transmitting the control message and in accordance with the repetitions, frequency hopping, demodulation reference signal bundling, scaling of a transport block size, lowering of a modulation order, lowering of a coding rate, slot or sub-slot aggregation, or any combination thereof.

In some examples, to support transmitting the control message indicating the one or more coverage enhancement schemes supported by the target cell, the coverage enhancement manager 1240 may be configured as or otherwise support a means for transmitting the control message indicating that the target cell supports maximum power reduction, or peak-to-average power ratio reduction, or both. In some examples, to support transmitting the control message indicating the one or more coverage enhancement schemes supported by the target cell, the coverage enhancement manager 1240 may be configured as or otherwise support a means for receiving one or more messages from the UE in accordance with the maximum power reduction, or the peak-to-average power ratio reduction, or both.

In some examples, to support transmitting the control message indicating the one or more coverage enhancement schemes supported by the target cell, the coverage enhancement manager 1240 may be configured as or otherwise support a means for transmitting the control message indicating that the target cell supports modification of one or more power control parameters for uplink messages to the network entity. In some examples, to support transmitting the control message indicating the one or more coverage enhancement schemes supported by the target cell, the coverage enhancement manager 1240 may be configured as or otherwise support a means for receiving, from the UE, one or more messages having one or more modified power control parameters based on the target cell supporting the modification of the one or more power control parameters.

In some examples, to support transmitting the control message indicating the one or more coverage enhancement schemes supported by the target cell, the coverage enhancement manager 1240 may be configured as or otherwise support a means for transmitting the control message indicating that the target cell supports scheduling of one or more reference signals that are associated with distance-based cell selection. In some examples, to support transmitting the control message indicating the one or more coverage enhancement schemes supported by the target cell, the coverage enhancement manager 1240 may be configured as or otherwise support a means for transmitting the one or more reference signals to the UE based on the target cell supporting the scheduling of the one or more reference signals.

In some examples, the capability manager 1250 may be configured as or otherwise support a means for receiving a capability message indicating a capability of the UE to support the one or more coverage enhancement schemes, where transmitting the control message indicating the one or more coverage enhancement schemes supported by the target cell is based on the capability of the UE to support the one or more coverage enhancement schemes.

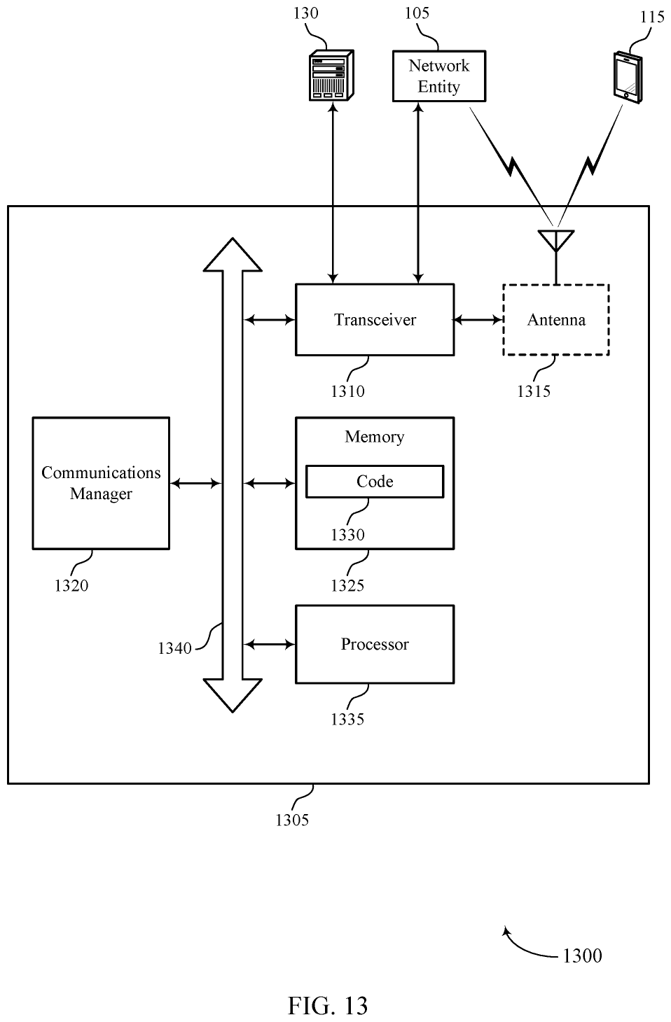

FIG. 13 illustrates a diagram of a system 1300 including a device 1305 that supports techniques for enhancing conditional changes of a serving cell in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable (e.g., processor-readable), computer-executable (e.g., processor-executable) code 1330 including instructions that, when executed by the processor 1335, cause the device 1305 to perform various functions described herein.

The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for enhancing conditional changes of a serving cell). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for receiving, from a UE, a message indicating UAI for a conditional change of a serving cell, a request for NAI for the conditional change of the serving cell, or both. The communications manager 1320 may be configured as or otherwise support a means for transmitting, to the UE, a control message that indicates a set of candidate cells for the conditional change of the serving cell.

Additionally, or alternatively, the communications manager 1320 may support wireless communication at a network entity in accordance with examples as disclosed herein. For example, the communications manager 1320 may be configured as or otherwise support a means for receiving a message indicating that a UE has selected a target cell associated with the network entity for a conditional change of a serving cell. The communications manager 1320 may be configured as or otherwise support a means for transmitting, to the UE and based on receiving the message, a control message indicating one or more coverage enhancement schemes supported by the target cell. The communications manager 1320 may be configured as or otherwise support a means for performing a random access procedure with the UE based on the conditional change of the serving cell, where signaling that is part of the random access procedure is based on the one or more coverage enhancement schemes supported by the target cell.

By including or configuring the communications manager 1320 in accordance with examples as described herein, the device 1305 may support techniques for conditional serving cell change procedures using reduced processing and with increased communication efficiency and robustness, which may improve user experience via longer battery life and improved reliability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of techniques for enhancing conditional changes of a serving cell as described herein, or the processor 1335 and the memory 1325 may be otherwise configured to perform or support such operations.

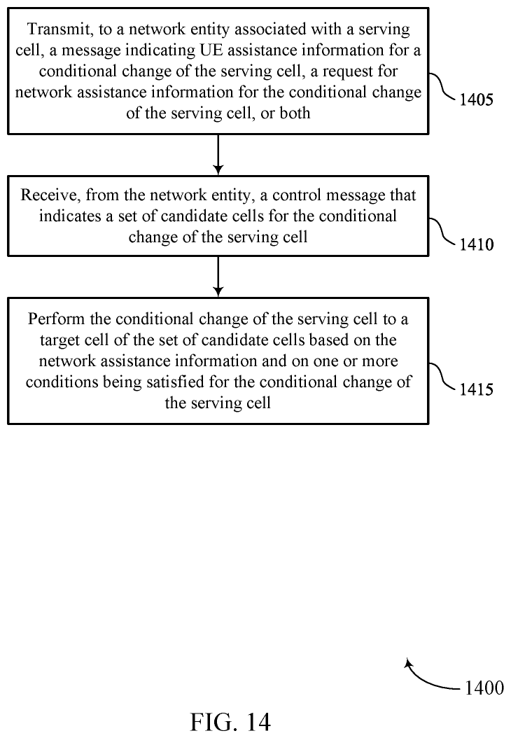

FIG. 14 illustrates a flowchart illustrating a method 1400 that supports techniques for enhancing conditional changes of a serving cell in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting, to a network entity associated with a serving cell, a message indicating UAI for a conditional change of the serving cell, a request for NAI for the conditional change of the serving cell, or both. The operations of 1405 may be performed in accordance with examples as disclosed herein. In some examples, aspects of the operations of 1405 may be performed by a UAI component 825 as described with reference to FIG. 8.

At 1410, the method may include receiving, from the network entity, a control message that indicates a set of candidate cells for the conditional change of the serving cell. The operations of 1410 may be performed in accordance with examples as disclosed herein. In some examples, aspects of the operations of 1410 may be performed by a candidate cell manager 830 as described with reference to FIG. 8.

At 1415, the method may include performing the conditional change of the serving cell to a target cell of the set of candidate cells based on the NAI and on one or more conditions being satisfied for the conditional change of the serving cell. The operations of 1415 may be performed in accordance with examples as disclosed herein. In some examples, aspects of the operations of 1415 may be performed by a cell change component 835 as described with reference to FIG. 8.

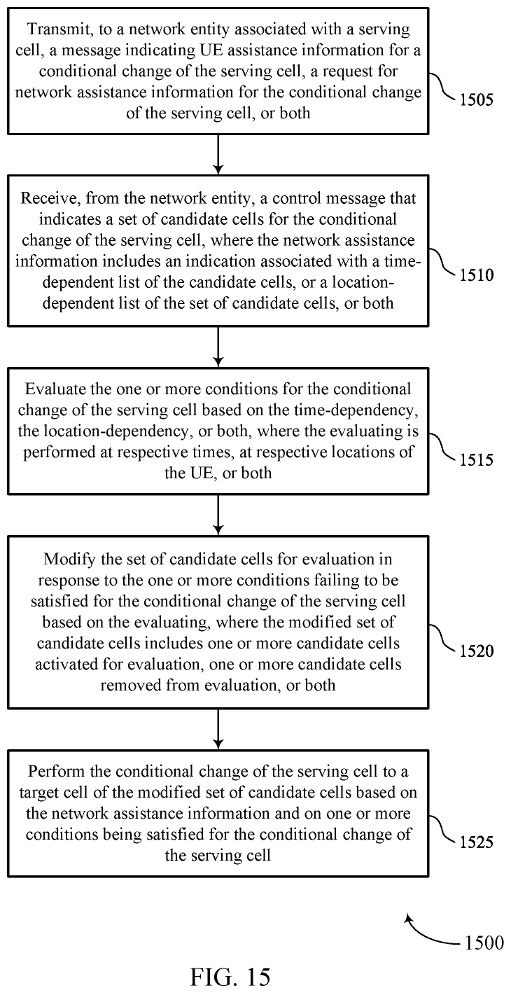

FIG. 15 illustrates a flowchart illustrating a method 1500 that supports techniques for enhancing conditional changes of a serving cell in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting, to a network entity associated with a serving cell, a message indicating UAI for a conditional change of the serving cell, a request for NAI for the conditional change of the serving cell, or both. The operations of 1505 may be performed in accordance with examples as disclosed herein. In some examples, aspects of the operations of 1505 may be performed by a UAI component 825 as described with reference to FIG. 8.

At 1510, the method may include receiving, from the network entity, a control message that indicates a set of candidate cells for the conditional change of the serving cell, where the NAI includes an indication associated with a time-dependent list of the candidate cells, or a location-dependent list of the set of candidate cells, or both. The operations of 1510 may be performed in accordance with examples as disclosed herein. In some examples, aspects of the operations of 1510 may be performed by a candidate cell manager 830 as described with reference to FIG. 8.

At 1515, the method may include evaluating the one or more conditions for the conditional change of the serving cell based on a time-dependency, a location-dependency, or both, where the evaluating is performed at respective times, at respective locations of the UE, or both. The operations of 1515 may be performed in accordance with examples as disclosed herein. In some examples, aspects of the operations of 1515 may be performed by a dependency component 870 as described with reference to FIG. 8.

At 1520, the method may include modifying the set of candidate cells for evaluation in response to the one or more conditions failing to be satisfied for the conditional change of the serving cell based on the evaluating, where the modified set of candidate cells includes one or more candidate cells activated for evaluation, one or more candidate cells removed from evaluation, or both. The operations of 1520 may be performed in accordance with examples as disclosed herein. In some examples, aspects of the operations of 1520 may be performed by a dependency component 870 as described with reference to FIG. 8.

At 1525, the method may include performing the conditional change of the serving cell to a target cell of the set of candidate cells based on the NAI and on one or more conditions being satisfied for the conditional change of the serving cell. The operations of 1525 may be performed in accordance with examples as disclosed herein. In some examples, aspects of the operations of 1525 may be performed by a cell change component 835 as described with reference to FIG. 8.

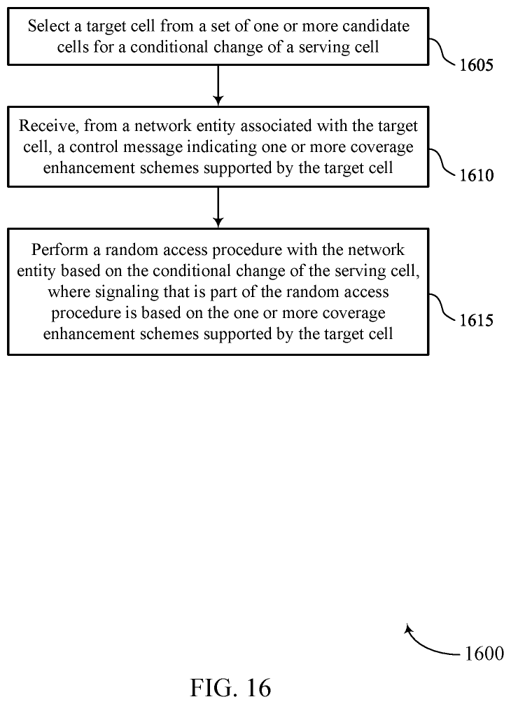

FIG. 16 illustrates a flowchart illustrating a method 1600 that supports techniques for enhancing conditional changes of a serving cell in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include selecting a target cell from a set of one or more candidate cells for a conditional change of a serving cell. The operations of 1605 may be performed in accordance with examples as disclosed herein. In some examples, aspects of the operations of 1605 may be performed by a cell selection component 840 as described with reference to FIG. 8.

At 1610, the method may include receiving, from a network entity associated with the target cell, a control message indicating one or more coverage enhancement schemes supported by the target cell. The operations of 1610 may be performed in accordance with examples as disclosed herein. In some examples, aspects of the operations of 1610 may be performed by a coverage enhancement component 845 as described with reference to FIG. 8.

At 1615, the method may include performing a random access procedure with the network entity based on the conditional change of the serving cell, where signaling that is part of the random access procedure is based on the one or more coverage enhancement schemes supported by the target cell. The operations of 1615 may be performed in accordance with examples as disclosed herein. In some examples, aspects of the operations of 1615 may be performed by a random access component 850 as described with reference to FIG. 8.

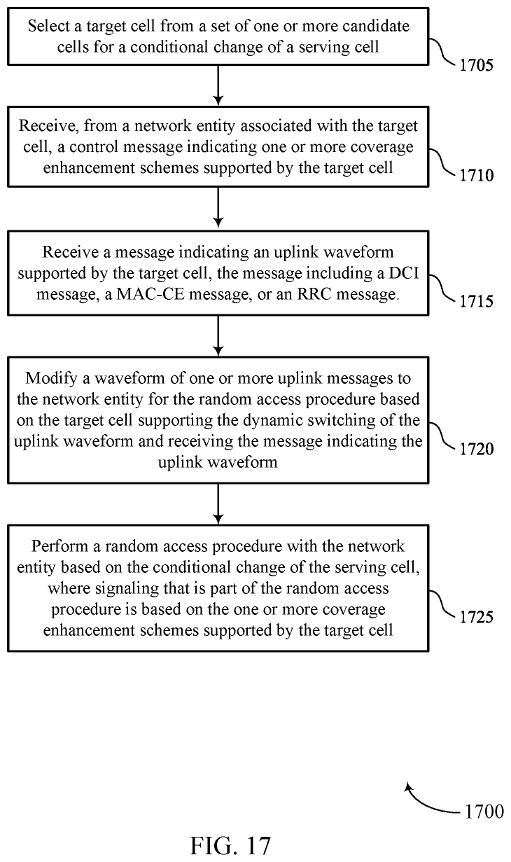

FIG. 17 illustrates a flowchart illustrating a method 1700 that supports techniques for enhancing conditional changes of a serving cell in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include selecting a target cell from a set of one or more candidate cells for a conditional change of a serving cell. The operations of 1705 may be performed in accordance with examples as disclosed herein. In some examples, aspects of the operations of 1705 may be performed by a cell selection component 840 as described with reference to FIG. 8.

At 1710, the method may include receiving, from a network entity associated with the target cell, a control message indicating one or more coverage enhancement schemes supported by the target cell. For example, the received control message may indicate that the target cell supports dynamic switching of an uplink waveform for the signaling that is part of the random access procedure. The operations of 1710 may be performed in accordance with examples as disclosed herein. In some examples, aspects of the operations of 1710 may be performed by a coverage enhancement component 845 as described with reference to FIG. 8.

At 1715, the method may include receiving a message indicating an uplink waveform supported by the target cell. In some examples, the message may be a DCI message, a MAC-CE message, or an RRC message. The operations of 1715 may be performed in accordance with examples as disclosed herein. In some examples, aspects of the operations of 1715 may be performed by a coverage enhancement component 845 as described with reference to FIG. 8.

At 1720, the method may include modifying a waveform of one or more uplink messages to the network entity for the random access procedure based on the target cell supporting the dynamic switching of the uplink waveform and receiving the message indicating the uplink waveform. The operations of 1720 may be performed in accordance with examples as disclosed herein. In some examples, aspects of the operations of 1720 may be performed by a coverage enhancement component 845 as described with reference to FIG. 8.

At 1725, the method may include performing a random access procedure with the network entity based on the conditional change of the serving cell, where signaling that is part of the random access procedure is based on the one or more coverage enhancement schemes supported by the target cell. The operations of 1725 may be performed in accordance with examples as disclosed herein. In some examples, aspects of the operations of 1725 may be performed by a random access component 850 as described with reference to FIG. 8.

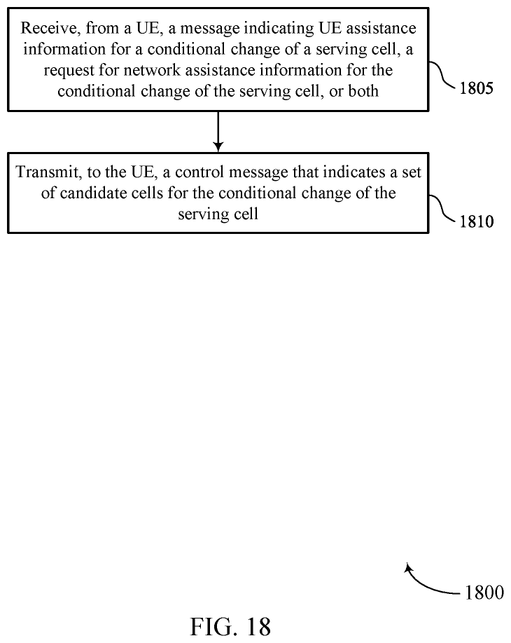

FIG. 18 illustrates a flowchart illustrating a method 1800 that supports techniques for enhancing conditional changes of a serving cell in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include receiving, from a UE, a message indicating UAI for a conditional change of a serving cell, a request for NAI for the conditional change of the serving cell, or both. The operations of 1805 may be performed in accordance with examples as disclosed herein. In some examples, aspects of the operations of 1805 may be performed by a UAI manager 1225 as described with reference to FIG. 12.

At 1810, the method may include transmitting, to the UE, a control message that indicates a set of candidate cells for the conditional change of the serving cell. The operations of 1810 may be performed in accordance with examples as disclosed herein. In some examples, aspects of the operations of 1810 may be performed by a NAI component 1230 as described with reference to FIG. 12.

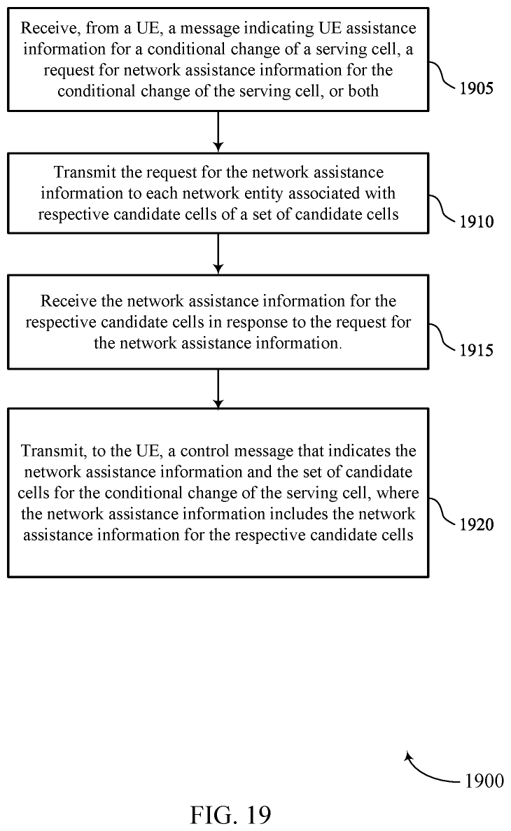

FIG. 19 illustrates a flowchart illustrating a method 1900 that supports techniques for enhancing conditional changes of a serving cell in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include receiving, from a UE, a message indicating UAI for a conditional change of a serving cell, a request for NAI for the conditional change of the serving cell, or both. The operations of 1905 may be performed in accordance with examples as disclosed herein. In some examples, aspects of the operations of 1905 may be performed by a UAI manager 1225 as described with reference to FIG. 12.

At 1910, the method may include transmitting, to the UE, a control message that indicates a set of candidate cells for the conditional change of the serving cell. The operations of 1910 may be performed in accordance with examples as disclosed herein. In some examples, aspects of the operations of 1910 may be performed by a NAI component 1230 as described with reference to FIG. 12.

At 1915, the method may include transmitting the request for the NAI to each network entity associated with respective candidate cells of the set of candidate cells. The operations of 1915 may be performed in accordance with examples as disclosed herein. In some examples, aspects of the operations of 1915 may be performed by a NAI component 1230 as described with reference to FIG. 12.

At 1920, the method may include receiving the NAI for the respective candidate cells in response to the request for the NAI, where the NAI includes the NAI for the respective candidate cells. The operations of 1920 may be performed in accordance with examples as disclosed herein. In some examples, aspects of the operations of 1920 may be performed by a NAI manager 1255 as described with reference to FIG. 12.

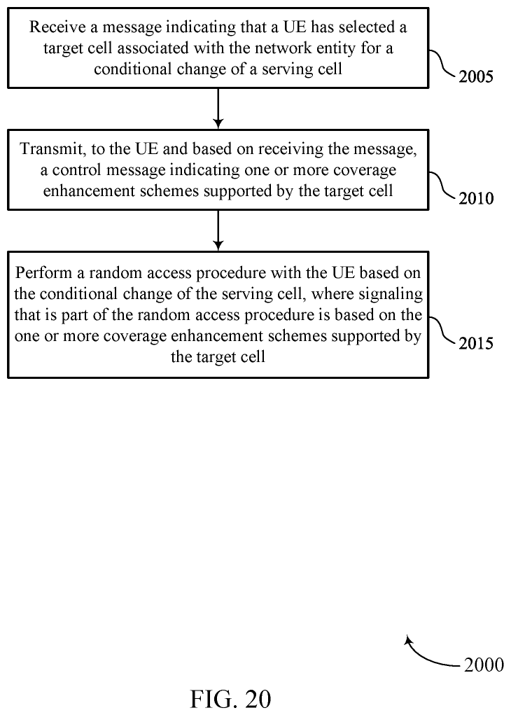

FIG. 20 illustrates a flowchart illustrating a method 2000 that supports techniques for enhancing conditional changes of a serving cell in accordance with one or more aspects of the present disclosure. The operations of the method 2000 may be implemented by a network entity or its components as described herein. For example, the operations of the method 2000 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2005, the method may include receiving a message indicating that a UE has selected a target cell associated with the network entity for a conditional change of a serving cell. The operations of 2005 may be performed in accordance with examples as disclosed herein. In some examples, aspects of the operations of 2005 may be performed by a target cell manager 1235 as described with reference to FIG. 12.

At 2010, the method may include transmitting, to the UE and based on receiving the message, a control message indicating one or more coverage enhancement schemes supported by the target cell. The operations of 2010 may be performed in accordance with examples as disclosed herein. In some examples, aspects of the operations of 2010 may be performed by a coverage enhancement manager 1240 as described with reference to FIG. 12.

At 2015, the method may include performing a random access procedure with the UE based on the conditional change of the serving cell, where signaling that is part of the random access procedure is based on the one or more coverage enhancement schemes supported by the target cell. The operations of 2015 may be performed in accordance with examples as disclosed herein. In some examples, aspects of the operations of 2015 may be performed by a random access manager 1245 as described with reference to FIG. 12.

The following provides an overview of aspects of the present disclosure:

Aspect 1: A method for wireless communication at a UE, comprising: transmitting, to a network entity associated with a serving cell, a message indicating UAI for a conditional change of the serving cell, a request for NAI for the conditional change of the serving cell, or both; receiving, from the network entity, a control message that indicates a set of candidate cells for the conditional change of the serving cell; and performing the conditional change of the serving cell to a target cell of the set of candidate cells based at least in part on the NAI and on one or more conditions being satisfied for the conditional change of the serving cell.

Aspect 2: The method of aspect 1, wherein the UAI indicates one or more coverage enhancement schemes supported by the UE, and the control message includes the NAI in response to the UAI and the request, the NAI being associated with at least one candidate cell of the set of candidate cells that support at least one of the one or more coverage enhancement schemes supported by the UE for downlink transmissions or uplink transmissions.

Aspect 3: The method of aspect 2, wherein the NAI comprises a loading status of one or more candidate cells of the set of candidate cells, a random access type associated with the one or more candidate cells, an indication of whether the one or more candidate cells support dynamic waveform switching, an indication of whether the one or more candidate cells support one or more coverage enhancement schemes, an indication of an energy saving status associated with each network entity providing the one or more candidate cells, an indication of whether the one or more candidate cells support data forwarding, or any combination thereof.

Aspect 4: The method of any of aspects 2 through 3, wherein the NAI comprises an indication of a time-dependency associated with the set of candidate cells, a location-dependency associated with the set of candidate cells, or both, the method further comprising: evaluating the one or more conditions for the conditional change of the serving cell based at least in part on the time-dependency, the location-dependency, or both, wherein the evaluating is performed at respective times, at respective locations of the UE, or both; and modifying the set of candidate cells for evaluation in response to the one or more conditions failing to be satisfied for the conditional change of the serving cell based on the evaluating, wherein the modified set of candidate cells includes one or more candidate cells activated for evaluation, one or more candidate cells removed from evaluation, or both.

Aspect 5: The method of any of aspects 1 through 4, wherein the UAI further indicates the request for the NAI, the method further comprising: receiving, from the network entity or a candidate cell of the set of candidate cells, one or more messages indicating the NAI in response to the request, the NAI being associated with at least one candidate cell of the set of candidate cells, wherein performing the conditional change of the serving cell is based at least in part on receiving the NAI.

Aspect 6: The method of any of aspects 1 through 5, further comprising: determining an offset value, or a hysteresis value, or both, for each candidate cell of the set of candidate cells, wherein each offset value, or each hysteresis value, or both, is mapped to a system loading status of a candidate cell, a network energy saving status of the candidate cell, one or more coverage enhancement schemes supported by the candidate cell, or any combination thereof; performing measurements of signals associated with respective candidate cells of the set of candidate cells and signals associated with the serving cell; and evaluating each candidate cell of the set of candidate cells for the conditional change of the serving cell based at least in part on the measurements, the offset value, or the hysteresis value, or any combination thereof.

Aspect 7: The method of aspect 6, further comprising: selecting the target cell from the set of candidate cells based at least in part on a sum of a measurement value for the target cell, an offset value for the target cell, and a hysteresis value for the target cell being greater than a measurement value for the serving cell.

Aspect 8: The method of any of aspects 6 through 7, further comprising: refraining from selecting a second candidate cell from the set of candidate cells based at least in part on a sum of a measurement value for the second candidate cell, an offset value for the second candidate cell, and a hysteresis value for the second candidate cell being less than a measurement value for the serving cell.

Aspect 9: The method of any of aspects 6 through 8, further comprising: determining a set of thresholds for the conditional change of the serving cell, each threshold of the set of thresholds corresponding to the system loading status of a candidate cell, the network energy saving status of the candidate cell, one or more coverage enhancement schemes supported by the candidate cell, or any combination thereof, wherein each candidate the set of candidate cells is evaluated based at least in part on the set of thresholds, the offset value, and the hysteresis value.

Aspect 10: The method of aspect 9, further comprising: selecting the target cell from the set of candidate cells based at least in part on a minimum of an offset value for the target cell and a hysteresis value for the target cell being less than a threshold value from the set of thresholds.

Aspect 11: The method of aspect 9, further comprising: refraining from selecting a second candidate cell from the set of candidate cells based at least in part on a minimum of an offset value for the second candidate cell and a hysteresis value for the first candidate cell being greater than a threshold value from the set of thresholds.

Aspect 12: The method of any of aspects 1 through 11, wherein the control message further indicates the set of candidate cells and a first configuration of the one or more conditions for performing the conditional change of the serving cell, the method further comprising: receiving a second control message indicating a second configuration of the one or more conditions, wherein performing the conditional change of the serving cell to the target cell is based at least in part on the second configuration of the one or more conditions.

Aspect 13: The method of any of aspects 1 through 12, wherein the UAI includes an indication of a preferred waveform, one or more coverage enhancement schemes supported by the UE, a buffer status report, a power headroom report, a preferred power budget for power aggregation at the UE, an estimate of a location of the UE, an estimate of a velocity of the UE, a report for a buffer status or a power headroom of the UE, an indication of one or more power saving configurations, a report of a capability of the UE associated with single-connectivity or multi-connectivity, or any combination thereof.

Aspect 14: A method for wireless communication at a UE, comprising: selecting a target cell from a set of one or more candidate cells for a conditional change of a serving cell; receiving, from a network entity associated with the target cell, a control message indicating one or more coverage enhancement schemes supported by the target cell; and performing a random access procedure with the network entity based at least in part on the conditional change of the serving cell, wherein signaling that is part of the random access procedure is based at least in part on the one or more coverage enhancement schemes supported by the target cell.

Aspect 15: The method of aspect 14, wherein receiving the control message indicating the one or more coverage enhancement schemes supported by the target cell comprises: receiving the control message indicating that the target cell supports dynamic switching of an uplink waveform for the signaling that is part of the random access procedure, the method further comprising: receiving a message indicating an uplink waveform supported by the target cell, the message comprising a DCI message, a MAC-CE message, or a RRC message; and modifying a waveform of one or more uplink messages to the network entity for the random access procedure based at least in part on the target cell supporting the dynamic switching of the uplink waveform and receiving the message indicating the uplink waveform.

Aspect 16: The method of any of aspects 14 through 15, wherein receiving the control message indicating the one or more coverage enhancement schemes supported by the target cell comprises: receiving the control message indicating that the target cell supports repetitions, frequency hopping, demodulation reference signal bundling, scaling of a transport block size, lowering of a modulation order, lowering of a coding rate, slot or sub-slot aggregation, or any combination thereof, for the signaling that is part of the random access procedure, the method further comprising: transmitting or receiving, for the random access procedure, one or more messages to the network entity or from the network entity based at least in part on receiving the control message and according to the repetitions, the frequency hopping, the demodulation reference signal bundling, the scaling of the transport block size, the lowering of the modulation order, the lowering of the coding rate, the slot or sub-slot aggregation, or the combination thereof.

Aspect 17: The method of any of aspects 14 through 16, wherein receiving the control message indicating the one or more coverage enhancement schemes supported by the target cell comprises: receiving the control message indicating that the target cell supports maximum power reduction, or peak-to-average power ratio reduction, or both, the method further comprising: transmitting one or more messages to the network entity using the maximum power reduction, or peak-to-average power ratio reduction, or both.

Aspect 18: The method of any of aspects 14 through 17, wherein receiving the control message indicating the one or more coverage enhancement schemes supported by the target cell comprises: receiving the control message indicating that the target cell supports modification of one or more power control parameters for uplink messages to the network entity, the method further comprising: transmitting one or more messages to the network entity based at least in part on modifying the one or more power control parameters, wherein the one or more power control parameters are modified based at least in part on uplink power aggregation and a specific absorption rate at the UE.

Aspect 19: The method of any of aspects 14 through 18, wherein receiving the control message indicating the one or more coverage enhancement schemes supported by the target cell comprises: receiving the control message indicating that the target cell supports scheduling of one or more reference signals that are associated with distance-based cell selection procedures, the method further comprising: measuring the one or more reference signals from the target cell for one or more distance-based cell selection procedures.

Aspect 20: The method of any of aspects 14 through 19, further comprising: transmitting a capability message indicating a capability of the UE to support the one or more coverage enhancement schemes, wherein receiving the control message indicating the one or more coverage enhancement schemes supported by the target cell is based at least in part on the capability of the UE to support the one or more coverage enhancement schemes.

Aspect 21: A method for wireless communication at a network entity, comprising: receiving, from a UE, a message indicating UAI for a conditional change of a serving cell, a request for NAI for the conditional change of the serving cell, or both; and transmitting, to the UE, a control message that indicates a set of candidate cells for the conditional change of the serving cell.

Aspect 22: The method of aspect 21, wherein the UAI indicates one or more coverage enhancement schemes supported by the UE, and the control message includes the NAI in response to the UAI and the request, the NAI being associated with at least one candidate cell of the set of candidate cells that support at least one of the one or more coverage enhancement schemes supported by the UE for downlink transmissions or uplink transmissions.

Aspect 23: The method of aspect 22, further comprising: transmitting the request for the NAI to each network entity associated with respective candidate cells of the set of candidate cells; and receiving the NAI for the respective candidate cells in response to the request for the NAI, wherein the one or more messages indicating the NAI includes the NAI for the respective candidate cells.

Aspect 24: The method of any of aspects 22 through 23, wherein the NAI comprises a loading status of one or more candidate cells of the set of candidate cells, a random access type associated with the one or more candidate cells, an indication of whether the one or more candidate cells support dynamic waveform switching, an indication of whether the one or more candidate cells support one or more coverage enhancement schemes, an indication of an energy saving status associated with each network entity providing the one or more candidate cells, an indication of whether the one or more candidate cells support data forwarding, or any combination thereof.

Aspect 25: The method of any of aspects 21 through 24, wherein the NAI comprises an indication of a time-dependency associated with the set of candidate cells, a location-dependency associated with the set of candidate cells, or both.

Aspect 26: The method of any of aspects 21 through 25, wherein the UAI indicates the request for the NAI, the method further comprising: transmitting, to the UE, one or more messages indicating the NAI in response to the request, the NAI being associated with at least one candidate cell of the set of candidate cells.

Aspect 27: The method of any of aspects 21 through 26, wherein the UAI includes an indication of a preferred waveform, one or more coverage enhancement schemes supported by the UE, a buffer status report, a power headroom report, a preferred power budget for power aggregation at the UE, an estimate of a location of the UE, an estimate of a velocity of the UE, a report for a buffer status or a power headroom of the UE, an indication of one or more power saving configurations, a report of a capability of the UE associated with single-connectivity or multi-connectivity, or any combination thereof.

Aspect 28: A method for wireless communication at a network entity, comprising: receiving a message indicating that a UE has selected a target cell associated with the network entity for a conditional change of a serving cell; transmitting, to the UE and based at least in part on receiving the message, a control message indicating one or more coverage enhancement schemes supported by the target cell; and performing a random access procedure with the UE based at least in part on the conditional change of the serving cell, wherein signaling that is part of the random access procedure is based at least in part on the one or more coverage enhancement schemes supported by the target cell.

Aspect 29: The method of aspect 28, wherein transmitting the control message indicating the one or more coverage enhancement schemes supported by the target cell comprises: transmitting the control message indicating that the target cell supports dynamic switching of an uplink waveform for the signaling that is part of the random access procedure, wherein one or more uplink messages from the UE for the random access procedure have a modified waveform based at least in part on the target cell supporting the dynamic switching of the uplink waveform.

Aspect 30: The method of any of aspects 28 through 29, wherein transmitting the control message indicating the one or more coverage enhancement schemes supported by the target cell comprises: transmitting the control message indicating that the target cell supports repetitions, frequency hopping, demodulation reference signal bundling, scaling of a transport block size, lowering of a modulation order, lowering of a coding rate, slot or sub-slot aggregation, or any combination thereof, for the signaling that is part of the random access procedure, the method further comprising: receiving or transmitting, for the random access procedure, one or more messages from the UE or to the UE based at least in part on transmitting the control message and in accordance with the repetitions, frequency hopping, demodulation reference signal bundling, scaling of a transport block size, lowering of a modulation order, lowering of a coding rate, slot or sub-slot aggregation, or combination thereof.

Aspect 31: The method of any of aspects 28 through 30, wherein transmitting the control message indicating the one or more coverage enhancement schemes supported by the target cell comprises: transmitting the control message indicating that the target cell supports maximum power reduction, or peak-to-average power ratio reduction, or both, the method further comprising: receiving one or more messages from the UE in accordance with the maximum power reduction, or the peak-to-average power ratio reduction, or both.

Aspect 32: The method of any of aspects 28 through 31, wherein transmitting the control message indicating the one or more coverage enhancement schemes supported by the target cell comprises: transmitting the control message indicating that the target cell supports modification of one or more power control parameters for uplink messages to the network entity, the method further comprising: receiving, from the UE, one or more messages having one or more modified power control parameters based at least in part on the target cell supporting the modification of the one or more power control parameters.

Aspect 33: The method of any of aspects 28 through 32, wherein transmitting the control message indicating the one or more coverage enhancement schemes supported by the target cell comprises: transmitting the control message indicating that the target cell supports scheduling of one or more reference signals that are associated with distance-based cell selection, the method further comprising:

transmitting the one or more reference signals to the UE based at least in part on the target cell supporting the scheduling of the one or more reference signals.

Aspect 34: The method of any of aspects 28 through 33, further comprising: receiving a capability message indicating a capability of the UE to support the one or more coverage enhancement schemes, wherein transmitting the control message indicating the one or more coverage enhancement schemes supported by the target cell is based at least in part on the capability of the UE to support the one or more coverage enhancement schemes.

Aspect 35: An apparatus (e.g., a UE) for wireless communication, comprising a processor; memory coupled with the processor; and instructions stored in the memory and executable by the processor to cause the apparatus to perform a method of any of aspects 1 through 13.

Aspect 36: An apparatus (e.g., a UE) for wireless communication, comprising at least one means for performing a method of any of aspects 1 through 13.

Aspect 37: A non-transitory computer-readable medium storing code for wireless communication at a UE, the code comprising instructions executable by a processor to perform a method of any of aspects 1 through 13.

Aspect 38: An apparatus (e.g., a UE) for wireless communication, comprising a processor; memory coupled with the processor; and instructions stored in the memory and executable by the processor to cause the apparatus to perform a method of any of aspects 14 through 20.

Aspect 39: An apparatus (e.g., a UE) for wireless communication, comprising at least one means for performing a method of any of aspects 14 through 20.

Aspect 40: A non-transitory computer-readable medium storing code for wireless communication at a UE, the code comprising instructions executable by a processor to perform a method of any of aspects 14 through 20.

Aspect 41: An apparatus (e.g., a network entity) for wireless communication, comprising a processor; memory coupled with the processor; and instructions stored in the memory and executable by the processor to cause the apparatus to perform a method of any of aspects 21 through 27.

Aspect 42: An apparatus (e.g., a network entity) for wireless communication, comprising at least one means for performing a method of any of aspects 21 through 27.

Aspect 43: A non-transitory computer-readable medium storing code for wireless communication at a network entity, the code comprising instructions executable by a processor to perform a method of any of aspects 21 through 27.

Aspect 44: An apparatus (e.g., a network entity) for wireless communication, comprising a processor; memory coupled with the processor; and instructions stored in the memory and executable by the processor to cause the apparatus to perform a method of any of aspects 28 through 34.

Aspect 45: An apparatus (e.g., a network entity) for wireless communication, comprising at least one means for performing a method of any of aspects 28 through 34.

Aspect 46: A non-transitory computer-readable medium storing code for wireless communication at a network entity, the code comprising instructions executable by a processor to perform a method of any of aspects 28 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories storing processor-executable code; and
one or more processors coupled with the one or more memories and operable to execute the code to cause the UE to:
transmit, to a network entity associated with a serving cell, a message indicating UE assistance information for a conditional change of the serving cell, a request for network assistance information for the conditional change of the serving cell, or both;
receive, from the network entity, a control message that indicates a set of candidate cells for the conditional change of the serving cell; and
perform the conditional change of the serving cell to a target cell of the set of candidate cells based at least in part on the network assistance information and on one or more conditions being satisfied for the conditional change of the serving cell.

2. The UE of claim 1, wherein:
the UE assistance information indicates one or more coverage enhancement schemes supported by the UE, and
the control message includes the network assistance information in response to the UE assistance information and the request, the network assistance information being associated with at least one candidate cell of the set of candidate cells that support at least one of the one or more coverage enhancement schemes supported by the UE for downlink transmissions or uplink transmissions.

3. The UE of claim 2, wherein the network assistance information comprises a loading status of one or more candidate cells of the set of candidate cells, a random access type associated with the one or more candidate cells, an indication of whether the one or more candidate cells support dynamic waveform switching, an indication of whether the one or more candidate cells support one or more coverage enhancement schemes, an indication of an energy saving status associated with each network entity providing the one or more candidate cells, an indication of whether the one or more candidate cells support data forwarding, or any combination thereof.

4. The UE of claim 2, wherein the network assistance information comprises an indication of a time-dependency associated with the set of candidate cells, a location-dependency associated with the set of candidate cells, or both, and the one or more processors are further operable to execute the code to cause the UE to:
evaluate the one or more conditions for the conditional change of the serving cell based at least in part on the time-dependency, the location-dependency, or both, wherein the evaluating is performed at respective times, at respective locations of the UE, or both; and
modify the set of candidate cells for evaluation in response to the one or more conditions failing to be satisfied for the conditional change of the serving cell based on the evaluating, wherein the modified set of candidate cells includes one or more candidate cells activated for evaluation, one or more candidate cells removed from evaluation, or both.

5. The UE of claim 1, wherein the UE assistance information further indicates the request for the network assistance information, and the one or more processors are further operable to execute the code to cause the UE to:
receive, from the network entity or a first candidate cell of the set of candidate cells, one or more messages indicating the network assistance information in response to the request, the network assistance information being associated with at least one candidate cell of the set of candidate cells, wherein performing the conditional change of the serving cell is based at least in part on receiving the network assistance information.

6. The UE of claim 1, wherein the one or more processors are further operable to execute the code to cause the UE to:
determine an offset value, or a hysteresis value, or both, for each candidate cell of the set of candidate cells, wherein each offset value, or each hysteresis value, or both, is mapped to a system loading status of a candidate cell, a network energy saving status of the candidate cell, one or more coverage enhancement schemes supported by the candidate cell, or any combination thereof;
perform measurements of signals associated with respective candidate cells of the set of candidate cells and signals associated with the serving cell; and
evaluate each candidate cell of the set of candidate cells for the conditional change of the serving cell based at least in part on the measurements, the offset value, or the hysteresis value, or any combination thereof.

7. The UE of claim 6, wherein the one or more processors are further operable to execute the code to cause the UE to:
select the target cell from the set of candidate cells based at least in part on a sum of a measurement value for the target cell, an offset value for the target cell, and a hysteresis value for the target cell being greater than a measurement value for the serving cell.

8. The UE of claim 6, wherein the one or more processors are further operable to execute the code to cause the UE to:
refrain from selecting a second candidate cell from the set of candidate cells based at least in part on a sum of a measurement value for the second candidate cell, an offset value for the second candidate cell, and a hysteresis value for the second candidate cell being less than a measurement value for the serving cell.

9. The UE of claim 6, wherein the one or more processors are further operable to execute the code to cause the UE to:
determine a set of thresholds for the conditional change of the serving cell, each threshold of the set of thresholds corresponding to the system loading status of a candidate cell, the network energy saving status of the candidate cell, one or more coverage enhancement schemes supported by the candidate cell, or any combination thereof, wherein each candidate the set of candidate cells is evaluated based at least in part on the set of thresholds, the offset value, and the hysteresis value.

10. The UE of claim 9, wherein the one or more processors are further operable to execute the code to cause the UE to:
select the target cell from the set of candidate cells based at least in part on a minimum of an offset value for the target cell and a hysteresis value for the target cell being less than a threshold value from the set of thresholds.

11. The UE of claim 9, wherein the one or more processors are further operable to execute the code to cause the UE to:
refrain from selecting a second candidate cell from the set of candidate cells based at least in part on a minimum of an offset value for the second candidate cell and a hysteresis value for the second candidate cell being greater than a threshold value from the set of thresholds.

12. The UE of claim 1, wherein the control message further indicates the set of candidate cells and a first configuration of the one or more conditions for performing the conditional change of the serving cell, and the one or more processors are further operable to execute the code to cause the UE to:
receive a second control message indicating a second configuration of the one or more conditions, wherein performing the conditional change of the serving cell to the target cell is based at least in part on the second configuration of the one or more conditions.

13. The UE of claim 1, wherein the UE assistance information includes an indication of a preferred waveform, one or more coverage enhancement schemes supported by the UE, a buffer status report, a power headroom report, a preferred power budget for power aggregation at the UE, an estimate of a location of the UE, an estimate of a velocity of the UE, a report for a buffer status or a power headroom of the UE, an indication of one or more power saving configurations, a report of a capability of the UE associated with single-connectivity or multi-connectivity, or any combination thereof.

14. A UE for wireless communication, comprising:
one or more memories storing processor-executable code; and
one or more processors coupled with the one or more memories and operable to execute the code to cause the UE to:
select a target cell from a set of one or more candidate cells for a conditional change of a serving cell;
receive, from a network entity associated with the target cell, a control message indicating one or more coverage enhancement schemes supported by the target cell; and
perform a random access procedure with the network entity based at least in part on the conditional change of the serving cell, wherein signaling that is part of the random access procedure is based at least in part on the one or more coverage enhancement schemes supported by the target cell.

15. The UE of claim 14, wherein, to receive the control message indicating the one or more coverage enhancement schemes supported by the target cell, the one or more processors are further operable to execute the code to cause the UE to:
receive the control message indicating that the target cell supports dynamic switching of an uplink waveform for the signaling that is part of the random access procedure, wherein the one or more processors are further operable to execute the code to cause the UE to:
receive a message indicating an uplink waveform supported by the target cell, the message comprising a downlink control information message, a medium access control-control element message, or a radio resource control message; and
modify a waveform of one or more uplink messages to the network entity for the random access procedure based at least in part on the target cell supporting the dynamic switching of the uplink waveform and receiving the message indicating the uplink waveform.

16. The UE of claim 14, wherein, to receive the control message indicating the one or more coverage enhancement schemes supported by the target cell, the one or more processors are further operable to execute the code to cause the UE to:
receive the control message indicating that the target cell supports repetitions, frequency hopping, demodulation reference signal bundling, scaling of a transport block size, lowering of a modulation order, lowering of a coding rate, slot or sub-slot aggregation, or any combination thereof, for the signaling that is part of the random access procedure, wherein the one or more processors are further operable to execute the code to cause the UE to:
transmit or receive, for the random access procedure, one or more messages to the network entity or from the network entity based at least in part on receiving the control message and according to the repetitions, the frequency hopping, the demodulation reference signal bundling, the scaling of the transport block size, the lowering of the modulation order, the lowering of the coding rate, the slot or sub-slot aggregation, or any combination thereof.

17. The UE of claim 14, wherein, to receive the control message indicating the one or more coverage enhancement schemes supported by the target cell, the one or more processors are further operable to execute the code to cause the UE to:
receive the control message indicating that the target cell supports maximum power reduction, or peak-to-average power ratio reduction, or both, wherein the one or more processors are further operable to execute the code to cause the UE to:
transmit one or more messages to the network entity using the maximum power reduction, or peak-to-average power ratio reduction, or both.

18. The UE of claim 14, wherein, to receive the control message indicating the one or more coverage enhancement schemes supported by the target cell, the one or more processors are further operable to execute the code to cause the UE to:
receive the control message indicating that the target cell supports modification of one or more power control parameters for uplink messages to the network entity, wherein the one or more processors are further operable to execute the code to cause the UE to:
transmit one or more messages to the network entity based at least in part on modifying the one or more power control parameters, wherein the one or more power control parameters are modified based at least in part on uplink power aggregation and a specific absorption rate at the UE.

19. The UE of claim 14, wherein, to receive the control message indicating the one or more coverage enhancement schemes supported by the target cell, the one or more processors are further operable to execute the code to cause the UE to:
receive the control message indicating that the target cell supports scheduling of one or more reference signals that are associated with distance-based cell selection procedures, wherein the one or more processors are further operable to execute the code to cause the UE to:
measure the one or more reference signals from the target cell for one or more distance-based cell selection procedures.

20. The UE of claim 14, wherein the one or more processors are further operable to execute the code to cause the UE to:
transmit a capability message indicating a capability of the UE to support the one or more coverage enhancement schemes, wherein receiving the control message indicating the one or more coverage enhancement schemes supported by the target cell is based at least in part on the capability of the UE to support the one or more coverage enhancement schemes.

21. A network entity for wireless communication, comprising:
one or more memories storing processor-executable code; and
one or more processors coupled with the one or more memories and operable to execute the code to cause the network entity to:
receive, from a user equipment (UE), a message indicating UE assistance information for a conditional change of a serving cell, a request for network assistance information for the conditional change of the serving cell, or both; and
transmit, to the UE, a control message that indicates a set of candidate cells for the conditional change of the serving cell.

22. The network entity of claim 21, wherein:
the UE assistance information indicates one or more coverage enhancement schemes supported by the UE, and
the control message includes the network assistance information in response to the UE assistance information and the request, the network assistance information being associated with at least one candidate cell of the set of candidate cells that support at least one of the one or more coverage enhancement schemes supported by the UE for downlink transmissions or uplink transmissions.

23. The network entity of claim 22, wherein the one or more processors are further operable to execute the code to cause the network entity to:
transmit the request for the network assistance information to each network entity associated with respective candidate cells of the set of candidate cells; and
receive the network assistance information for the respective candidate cells in response to the request for the network assistance information, wherein the network assistance information includes the network assistance information for the respective candidate cells.

24. The network entity of claim 21, wherein the network assistance information comprises an indication of a time-dependency associated with the set of candidate cells, a location-dependency associated with the set of candidate cells, or both.

25. The network entity of claim 21, wherein the UE assistance information indicates the request for the network assistance information, and the one or more processors are further operable to execute the code to cause the network entity to:
transmit, to the UE, one or more messages indicating the network assistance information in response to the request, the network assistance information being associated with at least one candidate cell of the set of candidate cells.

26. A network entity for wireless communication, comprising:
one or more memories storing processor-executable code; and
one or more processors coupled with the one or more memories and operable to execute the code to cause the network entity to:
receive a message indicating that a user equipment (UE) has selected a target cell associated with the network entity for a conditional change of a serving cell;
transmit, to the UE and based at least in part on receiving the message, a control message indicating one or more coverage enhancement schemes supported by the target cell; and
perform a random access procedure with the UE based at least in part on the conditional change of the serving cell, wherein signaling that is part of the random access procedure is based at least in part on the one or more coverage enhancement schemes supported by the target cell.

27. The network entity of claim 26, wherein, to transmit the control message indicating the one or more coverage enhancement schemes supported by the target cell, the one or more processors are further operable to execute the code to cause the network entity to:
transmit the control message indicating that the target cell supports dynamic switching of an uplink waveform for the signaling that is part of the random access procedure, wherein one or more uplink messages from the UE for the random access procedure have a modified waveform based at least in part on the target cell supporting the dynamic switching of the uplink waveform.

28. The network entity of claim 26, wherein, to transmit the control message indicating the one or more coverage enhancement schemes supported by the target cell, the one or more processors are further operable to execute the code to cause the network entity to:
transmit the control message indicating that the target cell supports repetitions, frequency hopping, demodulation reference signal bundling, scaling of a transport block size, lowering of a modulation order, lowering of a coding rate, slot or sub-slot aggregation, or any combination thereof, for the signaling that is part of the random access procedure, wherein the one or more processors are further operable to execute the code to cause the network entity to:
receive or transmit, for the random access procedure, one or more messages from the UE or to the UE based at least in part on transmitting the control message and in accordance with the repetitions, frequency hopping, demodulation reference signal bundling, scaling of a transport block size, lowering of a modulation order, lowering of a coding rate, slot or sub-slot aggregation, or any combination thereof.

29. The network entity of claim 26, wherein, to transmit the control message indicating the one or more coverage enhancement schemes supported by the target cell, the one or more processors are further operable to execute the code to cause the network entity to:
transmit the control message indicating that the target cell supports maximum power reduction, or peak-to-average power ratio reduction, or both, wherein the one or more processors are further operable to execute the code to cause the network entity to:
receive one or more messages from the UE in accordance with the maximum power reduction, or the peak-to-average power ratio reduction, or both.

30. The network entity of claim 26, wherein, to transmit the control message indicating the one or more coverage enhancement schemes supported by the target cell, the one or more processors are further operable to execute the code to cause the network entity to:
transmit the control message indicating that the target cell supports modification of one or more power control parameters for uplink messages to the network entity, wherein the one or more processors are further operable to execute the code to cause the network entity to:
receive, from the UE, one or more messages having one or more modified power control parameters based at least in part on the target cell supporting the modification of the one or more power control parameters.
